(19) United States
(12) Patent Application Publication
(10) Pub. No.: US 2026/0211874 A1
(43) Pub. Date: Jul. 23, 2026

(54) Query Language for Interrogating and Navigating Relational Data Collections

(71) Applicant: Bioinventors & Entrepreneurs Network LLC, Warren, NJ (US)

(72) Inventor: Michael Seul, Warren, NJ (US)

(21) Appl. No.: 19/538,902

(22) Filed: Feb. 12, 2026

Related U.S. Application Data
(63) Continuation-in-part of application No. 18/440,694, filed on Feb. 13, 2024.
Application No. 18/440,694 is a continuation-in-part of application No. 18/108,413, filed on Feb. 10, 2023, now abandoned.

(51) Int. Cl. G06F 16/242; G06F 16/2455; G06F 16/248; G06F 16/28

(52) U.S. Cl. CPC G06F 16/2445; G06F 16/2456; G06F 16/248; G06F 16/284

(57) ABSTRACT

Disclosed is a query language for querying a relational data store comprising records expressing a relation defined over the constituent elements, wherein the relational data store may be a relational table, and the relational table may conform to a generic tabular representation encoding arbitrarily deeply nested data sources. The query language invokes chainable methods defined on constructors for creating: query object having query clauses, including: a Find method for creating a find clause; and a Where method for creating a where clause having query patterns in key: value format; “key” identifying an attribute of elements of the records in the relational data store, and “value” comprising a predicate expression to be applied to the attribute identified in key; and a Run method for executing queries including queries for navigating and transforming the relational data store or its content; and a merge object having methods for performing pairwise joins, which may be chained.

### RELATED APPLICATIONS

This application is a continuation-in-part of U.S. application Ser. No. 18/440,694, entitled “System and Methods for Invoking Pattern Matching to Query Tabular Data Collections,” which is a continuation-in-part of U.S. application Ser. No. 18/108,413, entitled “A Universal Container for Structured and Unstructured Data from Disparate Sources, and Methods for Querying Same,” priority to which is claimed.

### BACKGROUND

The Structured Query Language (‘SQL’) remains to date the most widely used query language for relational databases. However, applications invoking SQL, in any of its common dialects, must include a special interface to the requisite relational database management software. Nor does the SQL syntax, especially for recursive queries, represent a model of transparency.

An alternative, introduced in the context of logic programming (“Structure and Interpretation of Computer Programs”, Abelson & Sussman, 2nd Edition, The MIT Press, Cambridge, MA 1996, Chapter 4.4), is pattern matching. To query a collection of data (‘facts’), constituent tuples are compared to congruent query patterns; thus, for data in Entity-Attribute-Value (or ‘E-A-V’) format, triples are compared to a pattern such as (?x c?y), and upon finding a matching triple (or ‘datum’) in the collection, the pattern variables?x and?y are bound to the corresponding values of that datum. Proceeding in this way, a collection of matching tuples is created (which may be empty). Simple queries may be combined by way of the logical operators AND, OR and NOT to form compound queries. Further, queries may be abstracted by introducing rules, in the form (rule <head> <body>) wherein head (or ‘conclusion’) is a pattern, and body (or ‘premise’) is any query; rule definitions may be recursive, such that a term or variable appears in the conclusion as well as the premise. A rule represents (the analog of) a logical implication, wherein a variable binding that satisfies the premise also satisfies the conclusion. Facts may be regarded as rules without body. The inclusion of rules in the data store permits the deductive retrieval of facts from the collection, as in Datalog.

What is desirable is a query language that invokes the concept of pattern matching to query relational data stores, in a tabular format having a preset number of named attributes, in wide or narrow representation (en.wikipedia.org web site under/wiki/Wide_and_narrow_data), wherein queries have the form of objects in the chosen implementation language. Eliminating dependencies on SQL or other special query languages and instead embedding queries natively in applications has the benefit of simplification and transparency, especially for lightweight applications, including but not limited to applications intended for mobile devices.

Especially desirable is the use of pattern matching to query data stores in GenericTabularRepresentation (‘gtr’), including but not limited to the implementation of chained self-joins, for aggregating selected content for presentation in a condensed tabular format, and relationship primitives, for navigating this representation, in a manner analogous to XPath Axes (developer.mozilla.org web site, under en-US/docs and further under/Web/XPath/Axes).

### SUMMARY

Disclosed herein are a system and methods for querying relational data collections, also referred to herein as RelationalDataStores, by matching records in the collection to query patterns specifying PredicateExpressions, preferably provided by way of user-defined functions, the system and methods implemented as a special-purpose language, preferably Javascript, obviating the need for SQL and related query languages. The system of the invention comprises an Interpreter, having a QueryEvaluator and a MergeEvaluator, both preferably JavaScript programs. The QueryEvaluator executes queries provided in the form of objects in the language of the Interpreter, preferably JavaScript objects. Query objects are created as object literals having named query clauses; preferably, query objects are created by invoking a query constructor having chainable methods for constructing and executing queries, which may recursive. Query sequences including transformation pipelines, for performing successive transformation of query results, preferably are created by a pipeline constructor having its own chainable methods invoking the query constructor. The MergeEvaluator executes joins for combining the results returned by a pair of queries, wherein joins may be chained. In a preferred embodiment, joins including chained joins and chained self-joins, are created and executed by invoking methods defined on a merge constructor. In one respect, the system and methods of the invention enable the implementation of fundamental types of queries directed to the GenericTabularRepresentation for transforming and navigating said representation.

### BRIEF DESCRIPTION OF THE FIGURES

FIG. 1 is a data flow diagram, in the form of a bi-partite graph, for execution of a query comprising multiple clauses such as find-, where- and in-clauses and variants of where-clause, as described herein; in the diagram, rectangles represent actions, ellipses represent input and output objects.

FIG. 2 is a data flow diagram for chaining of record sets arr_1, produced by a first query, and arr_2, produced by a second query, on a PredicateExpression—relating to Example E.1.

FIG. 3 is a schematic showing principal components of the Interpreter described in the various sections of the specification and illustrated in Examples.

FIG. 4A to 4D provide a set of data flow diagrams relating to Sections 3.1 & 3.2

4A relates to the query constructor and core methods.

4B relates to the Lambda and LambdaNext special methods of the query constructor; the dashed signature of the arrows connected to the this object indicate that chaining, by invoking the LambdaNext method one or more times, is optional.

4C relates to the Call and CallNext special methods of the query constructor; the dashed signature of the arrows connected to the this object indicate that chaining, by invoking the CallNext method one or more times, is optional.

4D relates to the special methods of the query constructor invoking relationship primitives.

FIG. 5 is a data flow diagram for the merge constructor, M, described in Sect 3.3 and illustrated for implementing a chained self-join, in Example E.3; the diagram shows the dependency of its A and B methods on the query constructor, Q, whose Run method in turn invokes the QueryEvaluator, and the dependency of its Merge and MergeNext methods on the function joinOnPredExpr, also referred to by its alias, merge; methods names are capitalized to distinguish them from function names, e.g. Merge vs merge; method chaining by way of the this object, not shown here, is described in the specification.

FIG. 6 is a depiction of a web form for collecting query input and submitting the assembled query for execution.

### BRIEF DESCRIPTION OF SOME OF THE TABLES

Table 1—Section of table in wide GenericTabularRepresentation generated from a primary JSON source; the table has seven columns, but is here displayed in split format given limited space-relating to Sect. 1 of the Specification and Example E.1.

Table 2—Principal constraints defining RelationshipPrimitives with reference to a given context node object, here denoted ‘cn’.

Table E.1.1—Tabular output returned by the SQL Query, labeled E1.1 in Example 1, directed to the data collection of Table 1-relating to Example 1.

Table E.2.1—Section of a table in wide GenericTabularRepresentation, generated from the HTML source of the National Cancer Institute Page www.cancer.gov/about-cancer for Approved Targeted Therapies under/treatment/types and further/targeted-therapies/approved-drug-list; compared to Table 1, this table comprises the additional columns Level (as defined), SourceId, for recording a reference to the primary data source, and Timestamp, for recording the time of creation of the table as a Current Epoch UNIX Timestamp; the table is displayed in split format given limited space-relating to Sect. 2 of the Specification and Example E.2.

Table E.2.1.1—Context node attribute record-relating to Example E.2.

Table E.2.1.2—Context node record-relating to Example E.2.

### DETAILED DESCRIPTION

It is to be understood that both the foregoing general description and the following detailed description are exemplary and explanatory and are intended to provide further explanation of the invention as claimed.

Unless otherwise defined, all technical and scientific terms used herein have the same meaning as commonly understood by one of ordinary skill in the art to which this invention belongs. Still, certain elements are defined for the sake of clarity and ease of reference.

### Definitions

The following terms are used herein as follows:
JavaScript, also simply ‘JS’, unless otherwise indicated, herein refers to modern ECMAScript vs 6 or higher, as described at webpage 262.ecma-international.org under ‘/6.0/’;
Key: Value Pair Syntax is a notation for assigning a value to a key, as in JavaScript Object Notation (‘JSON’) and in related data structures such as a JavaScript Map or a Python dictionary;
Path or NodePath is a key in a flattened representation of a nested object, in the form of string comprising the preferably dot-separated sequence of nodes traversed, from the root, to reach a specific node in the tree representing the original nested object;
Path-Encoded, as in path-encoded object, refers to an object whose keys are in the form of paths;
FunctionExpression is a string, a templated string or a template literal representing a JavaScript anonymous arrow function; for simplicity, the term ‘expression’ is applied herein to the actual expression as well as its representation;
PredicateExpression is a string, which may be templated, that is, comprise a substitution variable, or may be a JavaScript template literal or equivalent comprising one or more predicates en.wikipedia.org web site under/wiki/Predicate (mathematical logic), conforming to the syntax of an anonymous function expression; for simplicity, the term ‘expression’ is applied herein to the actual expression as well as its representation;
RelationalDataStore is a collection of records, provided in a tabular or non-tabular data structure comprising a multiplicity of records; in one embodiment, said collection is an array of objects, each object representing a record in the form of a collection of key: value pairs, each key identifying a user-named attribute and each value representing a specific value of the attribute identified by the key;
RelationalDataTable or RelationalTable is an instance of a RelationalDataStore in tabular format, comprising a collection of tuples, also referred to as records, each tuple representing an n-ary relation among its constituent elements, wherein n counts the number of the elements, and wherein elements have user-named attributes shown as column headers (see also en.wikipedia.org web site under/wiki/Relation_(database)); an Excel table, in ‘wide’ format, is an example of a RelationalTable;
and GenericTabularRepresentation is a special representation of a RelationalTable that encodes the structure of arbitrarily deeply nested primary sources, including but not limited to database tables, web pages sources, streams or files, the latter in a variety of formats including tagged and untagged formats, further described herein; the encoding comprises relative and absolute paths, wherein: relative paths are represented by pairs of recordNo, an integer numbering consecutive records in the RelationalTable, and parentRecordNo, an integer representing, for any record, the recordNo of the parental node in the said arbitrarily deeply nested source; and absolute paths preferably are represented by a uniquePropertyPath (‘uPP’), a string of dot-separated elements of the form level-recordNo, such as ‘0-0.1-3.2-188.3-196.4-221.5-3919.6-3924.7-3983.8-4763.9-4775.10-4777’, wherein level is an integer representing the depth of a specific node within the hierarchy, and wherein the root is at level 0;

### 0-Utility

In one aspect, the present invention discloses methods for querying, navigating and transforming a RelationalDataStore, which may be RelationalTable, by matching query patterns to the records in such a data store or table. In another aspect, the present invention discloses methods for forming, instantiating, transforming and executing query, pipeline and merge objects natively, within an application.

In preferred embodiments, methods of the invention apply to aRelationalTable conforming to the GenericTabularRepresentation for hierarchically structured (also herein ‘nested’) or unstructured data from sources of disparate type and format. Queries, and joins for navigating and transforming the GenericTabularRepresentation, with and without recursion, are disclosed and illustrated herein. The methods herein disclosed extend the utility of the GenericTabularRepresentation by providing a non-SQL query interface.

Among the practical benefits of the query language of the invention are: the ability to integrate queries and joins with application programs; in a preferred embodiment, wherein the Interpreter for the query language is a Javascript program, this includes the integration of queries and joins into HTML page sources; further, predicate expressions that appear in query patterns, and in the conditions for join (aka merge) operations, as elaborated herein, are provided as user-defined functions and therefore are not limited to ‘built-in’ operators, as in SQL.

Further, the query language of the invention can take advantage of all functionality provided in suitable implementation languages, preferably Javascript, namely ECMA-6 and later versions, for creating and transforming objects, which here are dynamic collections of clauses; and the method interface provides a transparent, flexible syntax for constructing query and merge objects and executing the corresponding operations.

### 1—Constructing and Executing Queries & Joins

In one embodiment of the query language of the invention, query objects are created as object literals; they are executed by invoking the QueryEvaluator, via its principal function query, also referred to as queryGTR. The record sets returned by execution of a pair of queries, each query directed to the same or to a different RelationalDataStore, are combined by way of a join, which may be a self-join, by invoking the function joinOnPredExpr, in later sections and examples herein also referred to by its alias, merge; joins, including self-joins, may be chained, as illustrated in subsequent sections.

The Query Object—In a preferred embodiment, a query of the invention is an object in the language of the QueryEvaluator. In a preferred embodiment, wherein the Interpreter is a JavaScript program, this object is a JavaScript object. In alternative embodiments, a query may be represented as an alternative data structure having key-value pairs, or equivalent, including but not limited to the JavaScript Map, which also provides additional methods (developer.mozilla.org web site under/en-US/docs/Web/JavaScript/Reference and further under/Global_Objects/Map). The term object, as used herein, covers all such alternatives, as appropriate.

The query object comprises named query clauses, in the form of key-value pairs (or equivalent), namely at least a find-clause, and, unless the entire data collection is to be returned, a where-clause. In a preferred embodiment, wherein the Interpreter is a JavaScript program, clauses comprise a key identifying the clause and a value comprising strings (‘Datalog in Javascript’ Stepan Parunashvili, Apr. 25, 2022 www.instantdb.com web site under/essays/datalogjs), namely strings or arrays of strings or, as disclosed herein, arrays of objects comprising strings, wherein strings with a leading “?” reference attributes of the data collection. Such strings are herein also referred to as variables, but are to be distinguished from variables in traditional pattern matching.

The find-clause comprises the key find and a value in the form of an array of variables identifying attributes to be included in the query output, wherein the special variable “?*”, indicates the selection of all attributes.

The where-clause comprises the key where and a value in the form of an array of objects, wherein, as disclosed and illustrated herein, each such object represents a query pattern in the form of a key-value pair whose key identifies an attribute of the records in the RelationalDataStore of interest, which attribute, in a RelationalTable, appears as a column name, as in “?gtrAttributeName”, and whose value is a predicate expression to be applied to the elements of the records, which may be the content of a table column, identified by the key. This structure of query patterns of the invention differs from that of patterns in classic pattern matching, which is an array that conforms to the tuple structure of the data collection.

A query of the invention optionally may comprise an in-clause and variants of the where-clause, as a group referred to herein as where-clauses, the group including at least a whereFurther-, a whereNext- and a recursive whereNext-clause, as well as other clauses, described in greater detail below.

Patterns as Constraints—In accordance with the present invention, patterns represent constraints, in the form of predicates or predicate expressions, preferably in the form of user-defined functions (“PredicateExpressions”) that are applied by filtering the data collection so as to select (or reject) sets of matching records, if any. Accordingly, a matching record herein means a record satisfying a constraint, that is: a record for which predicates in the corresponding query pattern evaluate to ‘true’.

In one embodiment, functions referenced in PredicateExpressions, including but not limited to isEQ, isPref, incr and decr, as invoked in illustrative queries herein, including in Examples, are pre-defined in the Interpreter. In a preferred implementation, wherein the language of the interpreter is Javascript, these functions may be defined as follows: isEQ=(x,y)=>x===y, isPref=(pref,s)=>s.starts With (pref) and incr=(x)=>x+1, decr=(x)=>x-1. Additional functions, including aggregate functions such as count, sum, average may be likewise defined in the global environment.

Queries comprising two or more patterns are executed by applying each pattern in turn, then combining the resulting two or more record sets by conjunction, corresponding to the logical AND operator, herein the default operation, or disjunction, corresponding to logical OR operator. When querying a relational data store, including w-gtr, all matching records have the same structure, and combining comprises, for conjunction, the intersection and, for disjunction, the union of the two or more tuple sets, as illustrated herein below.

This is in contrast to embodiments of pattern matching, as in Datalog, wherein the tuple sets generated by applying constraints to a data collection in Entity-Attribute-Value (‘E-A-V’) or a related generic information format are JOIN-ed pairwise on a shared variable, preferably recursively, after arranging a sequence of patterns so as to ensure that sets generated by application of adjacent patterns share a variable on which to execute the JOIN (‘Datalog in Javascript’ Stepan Parunashvili, Apr. 25, 2022 www.instantdb.com web site under/essays/datalogjs).

Creating the Query Object—As disclosed and illustrated herein, a query object may be defined as an object literal; or may be created by invoking an object constructor; or may be provided as a JSON file or API payload; alternatively, a query object may be created dynamically within an application, as disclosed and illustrated herein.

### Executing Queries—

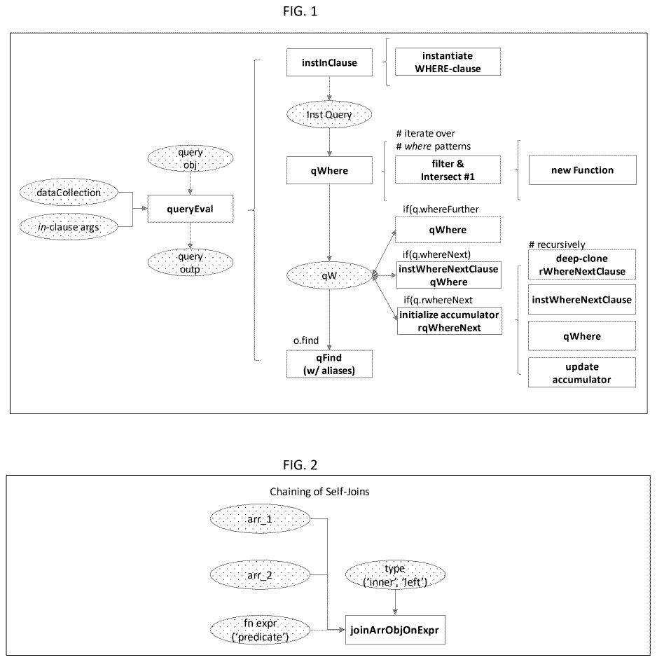

To execute a query, the query object is provided, as one argument, to a query evaluating and executing function of the Interpreter, herein ‘QueryEvaluator’, along with further arguments comprising at least the name of the data collection of interest, and where appropriate an argument for instantiating parametrized queries, as disclosed and illustrated herein. The dataflow for processing a query in accordance with the system and methods of the invention is shown in FIG. 1. In a preferred embodiment, the Interpreter of the query language of the present invention is implemented in Javascript. In other embodiments, it may be implemented in other programming languages supporting objects (or equivalent data structures) and a functionality for evaluating strings, to produce valid predicate expressions.

1.1 Simple Queries: Find- and where-Clauses

Table 1 shows a section of a larger w-gtr table (of 2,265 records) having seven attributes, generated from a nested JSON file reporting the results of a genomic scan of a sample from an oncology patient, including information on several mutations.

TABLE 1

| recordNo | parentRcNo | leaf | uniquePropPath |
|---|---|---|---|
| 46404 | 46402 | 1 | 0-0.1-5.2-46399.3-46401.4-46402.5-46404 |
| 46405 | 46404 | 1 | 0-0.1-5.2-46399.3-46401.4-46402.5-46404.6-46405 |
| 46406 | 46405 | 1 | 0-0.1-5.2-46399.3-46401.4-46402.5-46404.6-46405.7-46406 |
| 46407 | 46406 | 0 | 0-0.1-5.2-46399.3-46401.4-46402.5-46404.6-46405.7-46406.8-46407 |
| 46408 | 46406 | 1 | 0-0.1-5.2-46399.3-46401.4-46402.5-46404.6-46405.7-46406.8-46408 |
| 46409 | 46408 | 0 | 0-0.1-5.2-46399.3-46401.4-46402.5-46404.6-46405.7-46406.8-46408.9-46409 |
| 46410 | 46408 | 0 | 0-0.1-5.2-46399.3-46401.4-46402.5-46404.6-46405.7-46406.8-46408.9-46410 |
| 46411 | 46408 | 0 | 0-0.1-5.2-46399.3-46401.4-46402.5-46404.6-46405.7-46406.8-46408.9-46411 |
| 46412 | 46406 | 0 | 0-0.1-5.2-46399.3-46401.4-46402.5-46404.6-46405.7-46406.8-46412 |
| 46413 | 46406 | 0 | 0-0.1-5.2-46399.3-46401.4-46402.5-46404.6-46405.7-46406.8-46413 |
| 46414 | 46406 | 0 | 0-0.1-5.2-46399.3-46401.4-46402.5-46404.6-46405.7-46406.8-46414 |
| 46415 | 46406 | 0 | 0-0.1-5.2-46399.3-46401.4-46402.5-46404.6-46405.7-46406.8-46415 |

| propPath | propKey | propVal |
|---|---|---|
| content[12].content[0].hgvsNomenclature | hgvsNomenclature | (null) |
| content[12].content[0].hgvsNomenclature.cSyntaxes | cSyntaxes | (null) |
| content[12].content[0].hgvsNomenclature.cSyntaxes[0] | 0 | (null) |
| content[12].content[0].hgvsNomenclature.cSyntaxes[0].consequence | consequence | non_synonymous |
| content[12].content[0].hgvsNomenclature.cSyntaxes[0].gene | gene | (null) |
| content[12].content[0].hgvsNomenclature.cSyntaxes[0].gene.symbol | symbol | MSH2 |
| content[12].content[0].hgvsNomenclature.cSyntaxes[0].gene.identifier | identifier | 4436 |
| content[12].content[0].hgvsNomenclature.cSyntaxes[0].gene.cytogenicLocation | cytogenicLocation | 2p21 |
| content[12].content[0].hgvsNomenclature.cSyntaxes[0].pSyntax | pSyntax | NP_000242.1: p.N596* |
| content[12].content[0].hgvsNomenclature.cSyntaxes[0].source | source | refseq |
| content[12].content[0].hgvsNomenclature.cSyntaxes[0].transcSyntax | transcSyntax | NM_000251.2: c.1786_1787delAA |
| content[12].content[0].hgvsNomenclature.cSyntaxes[0].chromcSyntax | chromcSyntax | chr2(NM_000251.2): c.1786_1787delAA |

The following simple query illustrates the structure of each clause, in the form of a key-value pair, wherein value, for the find-clause, is an array of strings, each string comprising a variable referring to an attribute while also specifying an (optional) alias, indicated by the infix ‘_AS_’; and, for the where-clause, is an array of objects, the array here comprising a single query pattern having a key that identifies an attribute in Table 1, and a value comprising a PredicateExpression. Prior to evaluating this expression, the Interpreter substitutes for the variable x, the variable specified in the pattern key, here x.propPath.

In accordance with the where-clause, the query retrieves records that include the symbols of mutated genes, and, in accordance with the find-clause, reports the symbols of any such genes along with the corresponding uniquePropPath.

Query 1.1.1

```
let qGTR = {
  find: [″?propVal_AS_geneSymbol″,″?uniquePropPath_AS_uPP″],
  where: [
    {″?propPath″:″(x) => x.includes(′cSyntaxes[0].gene.symbol′)″}
  ]
}
```

The query is executed by invoking a query evaluating and executing function (‘QueryEvaluator’), here named queryEval or simply query, with arguments comprising: the name of the query object, for example qGTR and the name of the data collection of interest, for example gtrTb, thus query (qGTR, gtrTb). With Query 1.1.1, this function returns a set of 19 records (of which only the first and last several are shown):

```
[
  {
    geneId: ′TERT′,
    uPP: ′.0-0.1-5.2-21.3-23.4-24.5-26.6-28.7-29.8-30.9-32.10-33′
  },
  {
    geneId: ′TP53′,
    uPP: ′.0-0.1-5.2-21.3-23.4-5010.5-5012.6-5014.7-5015.8-
    5016.9-5018.10-5019′
  },
      ...
  {
    geneId: ′ERBB2′,
    uPP: ′.0-0.1-5.2-46399.3-46401.4-162742.5-162744.6-162745.7-
    162746.8-162748.9-162749′
  },
  {
    geneId: ′GNAS′,
    uPP: ′.0-0.1-5.2-46399.3-46401.4-163330.5-163332.6-163333.7-
    163334.8-163336.9-163337′
  }
]
```

To constrain the returned record set, for example to a specific known gene symbol, if present in the data set, a suitable constraint is added in the form of a second query pattern, as in:

```
Query 1.1.2
qGTR = {
  find: [″?propVal_AS_geneId″,″?uniquePropPath_AS_uPP″],
  where: [
    {″?propPath″:″(x) => x.includes(′cSyntaxes[0].gene.symbol′)″},
    {″?propVal″:″(x) => isEQ(x, ′TP53′)″}
  ]
}
```

to obtain:

```
[
  {
    geneId: ′TP53′,
    uPP: ′.0-0.1-5.2-21.3-23.4-5010.5-5012.6-5014.7-5015.8-5016.9-
    5018.10-5019′
  },
  {
    geneId: ′TP53′,
    uPP: ′.0-0.1-5.2-21.3-23.4-22178.5-22180.6-22181.7-22182.8-
    22183.9-22185.10-22186′
  },
  {
    geneId: ′TP53′,
    uPP: ′.0-0.1-5.2-46399.3-46401.4-108048.5-108049.6-108050.7-
    108051.8-108053.9-108054′
  },
  {
    geneId: ′TP53′,
    uPP: ′.0-0.1-5.2-46399.3-46401.4-122971.5-122973.6-122974.7-
    122975.8-122977.9-122978′
  }
]
```

This record set represents the intersection of the sets returned by applying, serially, the constraints in the two query patterns, reflecting the conjunction of the two patterns. Additional patterns may be inserted, as desirable, in any order.

To enhance its expressiveness, the query language of the invention supports queries having additional clauses.

Execution Efficiency—In one respect, a whereFurther-clause provides a means of improving execution efficiency, by reducing the number of filtering operations, wherein patterns in a whereFurther-clause represent supplemental constraints to be applied only to record sets returned by execution of a where-clause. Tis is illustrated in Example 1.

Additional clauses are introduced in the context of devising parametrized queries, though they are not thereby limited to that use case.

### 1.2 Parametrized Queries

To further enhance the functionality and utility of the query language, the methods of the present invention further support parametrized queries.

1.2.1 in-Clause

In one embodiment, parametrization comprises introducing into the query object an in-clause to provide a uniform interface for conveying information to the query object. The in-clause value is a string, or an array of strings comprising strings representing variables, matching variables in one of the query patterns (Datomic Datalog, learndatalogtoday.org website); these variables are instantiated by substituting values provided as additional arguments to the QueryEvaluator, for example “?geneSymbols” in the following query:

Query 1.2.1

```
let pqGTR = {
  find: [″?propVal_AS_GeneSymbol″,″?uniquePropPath″],
  in: ″?geneSymbols″,
  where: [
    {″?propKey″:″(x) => x === ′symbol′″},
    {″?propVal″:″?geneSymbols″},
    {″?propPath″:″(x) => x.includes(′cSyntaxes[0]′)″}
  ]
}
```

Accordingly, invoking the QueryEvaluator with Query 1.2.1, the name of the data store, for example ‘gtrTb’, and an additional argument, for example geneSymbols= ‘TP53’, thus query (pqGTR, gtrTb, geneSymbols), reproduces the output of Query 1.1.2, in this Section, above. In accordance with the dataflow diagram of FIG. 1, the argument gene Symbols is substituted for the value of the in-clause, “?geneSymbols”, and this in turn replaces the matching variable in the where-clause. In a preferred embodiment, the Interpreter applies the instantiated constraint using the default predicate ‘is equal’, or ‘===’ (which also may be explicitly specified, as in the example of the first pattern).

More generally, as with the SQL IN clause, the in-clause accommodates a list of arguments. Thus, to extract information for a pair of genes, the parametrized Query 1.2.1 is executed by invoking the QueryEvaluator with an additional argument in the form of an array, for example geneSymbols = [′TP53′, ‘MSH2’], whereupon query (qpGTR, gtrTb, geneSymbols), returns a record set representing the union of the record sets produced by iterating the query over the individual elements of geneSymbols. In a preferred embodiment, the QueryEvaluator applies an instantiated constraint comprising an array of values using the default predicate ‘array.includes (x)’, that is, in this example, {“?prop Val”: “?geneSymbols”}, after instantiation, expands to {“?prop Val”: “(x)=> [′TP53′, ‘MSH2’].includes (x)”}.

Optionally, the QueryEvaluator also accommodates a variant of the in-clause syntax, in: “[ . . . ? geneSymbols]”, providing a mnemonic device that recalls the JavaScript destructuring assignment to indicate that arguments to the QueryEvaluator are expected in the form of an array. In a preferred embodiment, the in-clause accommodates PredicateExpressions, provided as arguments to the QueryEvaluator, thereby significantly expanding the functionality of the query language of the invention. For example, to extract information for all genes with symbols containing the letter ‘T’, the parametrized Query 1.2.1 may be executed by invoking the QueryEvaluator with geneSymbols= “(x)=>x.includes (‘T’)” to return a record set of 10 records, in the format above, comprising entries for the gene symbols ‘TERT’, ‘TP53’,‘TSC1’,‘ATM’, ‘TSC2’.

1.2.2 where-Clauses

In addition to the where- and whereFurther-clauses, queries may have additional variants of where-clauses, including but not limited to a non-recursive or a recursive whereNext-clause.

Other-Referencing and Self-Referencing Queries—In one respect, where-clauses comprising PredicateExpressions provide a means of referencing second objects, defined or created external to the query object, as well as record sets created by applying constraints in preceding clauses of the query.

A query of the former type, also referred to herein as ‘other-referencing’, preferably comprises a where- or a whereFurther-clause having at least one pattern comprising a PredicateExpression in the form of a template literal that references an object previously defined or created.

A query of the latter type, also referred to herein as ‘self-referencing’, preferably comprises a whereNext-clause having at least one pattern comprising a parametrized PredicateExpression, wherein, prior to executing that clause, constituent substitution variables are instantiated, by referencing values in record sets returned by executing a preceding where- or whereFurther clause. Self-referencing queries provide an alternative means of devising and executing a sequence of separate queries enabling a more compact and transparent query design.

Recursive Queries-Self-referencing queries may be recursive. In lieue of the whereNext-clause of a self-referencing query, a recursive query comprises an rwhereNext-clause, alternatively named whereNextRc, to reference the tuple set returned by executing the preceding where-clause, or the record set returned by a previous instantiation of the rwhereNext-clause itself. Self-referencing and recursive queries are illustrated in Example E.2.

### 1.2.3 Method-Clause

A query object further may have a method clause. In one respect, a method clause comprises a a means for accessing the record set returned by executing a preceding clause. In one embodiment, the method clause comprises a function expression specifying an aggregate function to be applied to the record set returned by the preceding clause specified in the clause. For example, the method clause:

$$method : [ \{ “ ? where ” : “ ( x ) \text{=>} count ( x ) ” \} ]$$

causes the Interpreter to display the number of records returned by the preceding where-clause. In other respects, the method clause provides the means for implementing additional aggregate functions such as min, max, average and sum, or other transformations.

### 1.3 Compound Queries

Combining Simple Queries—In one embodiment, compound queries are formed by combining individual query patterns by way of the logical operators AND (‘conjunction’), OR (‘disjunction’) and NOT (‘negation’), wherein the query output is obtained by forming the intersection, the union and or the complement, respectively, of the record set(s) returned by applying individual patterns. Preferably, and by default herein, query patterns are combined by conjunction.

To accommodate the logical operators, the syntax of the query object may be expanded, as in the following.

Query 1.3.1

```
let pqGTR = {
  find: [″?propVal_AS_GeneSymbol″,″?uniquePropPath″],
  in: ″?geneSymbols″,
    where: [{
      ″″ : {″?propKey″:″(x) => x === ′symbol′″},
      ″AND″ : {″?propVal″:″?geneSymbols″},
      ″OR″ : {″?propPath″:″(x) => x.includes(′cSyntaxes[0]′)”}
    }]
}
```

Compound Queries by PredicateExpression—In one respect, Predicate Expressions provide the preferred means for devising compound queries.

For example, the record set of 10 records returned by Query 1.2.1, in the preceding sub-section, with the PredicateExpression “(x)=>x.includes (‘T’)” may be expanded by including information such that ‘propKey’ may satisfy one of several constraints, in a manner equivalent to combining individual constraints by the OR operator. This is illustrated by the following query, wherein the pattern {“?propKey”: “(x)=>x=== ‘symbol”} is replaced by {“?propKey”: “(x)=> [′symbol’, ‘identifier’].includes (x)”}.

Query 1.3.2

```
qpGTR = {
  find: [″?propVal_AS_GeneSymbol/-Identifier″,″?uniquePropPath″],
  in: ″?geneSymbols″,
  where: [
    {″?propKey″:″(x) => [′symbol′,′identifier′].includes(x)″},
    {″?propVal″:″?geneSymbols″},
    {″?propPath″:″(x) => x.includes(′cSyntaxes[0]′)″}
  ]
}
```

For example, execution with geneSymbols= “(x)=>x.includes (‘T’)∥ (6000<x && x<7200)”, returns the union of the record sets returned by executing the query with only the first and only the second condition in the PredicateExpression, where (with reference to Table 1) the first condition specifies values of propVal with propKey equal to symbol and the second condition sets the range of acceptable values of propVal with propKey equal to identifier.

### 1.4 Dynamic Queries

In one embodiment, queries are formed and transformed programmatically by JavaScript functions for manipulating objects. In a preferred embodiment, a set of functions to this end includes, but is not limited to:

1.4.1 Creating a Minimal Query Object Comprising Find and where Clauses

```
const newQuery = ( ) => {
  let q = new Object( );
  q.find = [″?*″];
  q.where = [[″?attributeNm″,″?value″]];
  return q;
};
//Usage:
let qGTR = newQuery( );
```

### 1.4.2 Appending a Query Clause

```
const appendClause = (q, key, val) => {
  q[key] = val;
  return q;
}
//Usage:
let qGTR = appendClause(qGTR,″whereFurther″,″?value″);
```

### 1.4.3 Inserting Clauses at Specific Positions in the Object

```
const insertClause = (q, key, val, after=″) => {
  if(after.length === 0){
    q[key] = val;
    return q
  } else {
    let ix = Object.keys(q).findIndex(key => key === after);
    let oe = Object.entries(q);
    oe.splice(ix+1, 0, [key,val]);
    return Object.fromEntries(oe);
  }
}
// usage
let pqGTR = newQuery( )
pqGTR = insertClause(qGR,″in″,″?value″,″find″); // insert ‘in’ after ‘find’
pqGTR = insertClause(pqGTR,″whereFurther″,
  [[″?attributeNm″,″value″]]);
// outp:
{
  find: [ ′?*′ ],
  in: ′?varName′,
  where: [ [ ′?attributeNm, ′value′ ] ]
  whereFurther: [ [ ′?attributeNm′, ′value′ ] ]
}
```

The integration of these operations into native applications further enhances the utility of the methods of the invention.

### 1.5 Combining Query Outputs: Join (‘Merge’) Operation

The query language of the invention further provides a join operation for combining the record sets returned by execution of a pair of queries, wherein queries may be directed to the same or different RelationalDataStores; the former case is herein referred to as a self-join. Joins, and self-joins, may be chained, as illustrated for self-joins, in Sections 2.1 & 3.4.2 and illustrated in related Examples.

In one embodiment, the join operation is performed by invoking the function joinOnPredExpr, elsewhere herein also referred to by its alias, merge, which accepts these arguments: the outputs returned by executing the first and second queries, each in the form of an array of objects; and at least one PredicateExpression specifying a condition to be satisfied by the said elements of the first and second record sets; and string specifying the type of join to be performed, including such settings as ‘inner’, the default, ‘left’ and ‘right’.

In the preferred embodiment of the Interpreter, wherein the language of implementation is Javascript, PredicateEpressions are in the form of arrow functions, each specifying a condition to be matched by entries in the said first and second arrays of objects; as described in preceding sub-sections, queries are executed by invoking the QueryEvaluator, via the function query, also referred to herein by its alias, queryGTR.

Box 1.5.1
let a = query(qObj_a, tb_a);
let b = query(qObj_b, tb_b);
let ab = merge(a, b, “(e1,e2) => someFn(e1.Attr_a, e2.Attr_b)” )

The at least one PredicateExpression tests a condition on the pair of specified attributes provided as arguments to ‘someFn’, the first argument referring to an attribute in the first array of objects, say a, and a second argument referring to an attribute of the second array of objects, say b. Examples of ‘someFn’ are isEQ or isPref. shown in Examples. In a preferred embodiment, the merge function accommodates an array of PredicateExpressions, and applies them conjunctively.

If both queries are directed to the same RelationalDataStore, tb_a=tb_a=gtrTb, say, then the join operation is referred to as a self-join, as in this example:

Box 1.5.2
let a = query(qGTR_a, gtrTb);
let b = query(qGTR_b, gtrTb);
let ab = join OnPredExpr(a, b,
“(e1,e2) => isPref(‘4-’.concat(e1.parentRecordNo),e2.uniquePropPath)”)

The application of the self-join operation to RelationalDataStores conforming to the Generic Tabular Representation and the application of chained self-joins to the transformation of such RelationalDatStores in GenericTabularRepresentation is illustrated in Examples E.1 & E.3.

In certain embodiment, wherein a RelationalDataStore holds record collections from two or more primary sources, each such record collection identified by origin, the syntax of the at least one PredicateExpression may be generalized to include in the pair of arguments provided to the at least one PredicateExpression identifiers of the respective primary sources.

### 2-Transforming & Navigating the Generic Tabular Representation

### 2.1 Chained Self-Joins

An essential transformation of the GenericTabularRepresentation is that of aggregating selected content in a tabular format having user-selected columns. In a preferred embodiment, this is achieved by executing a sequence of individual queries, each directed to a specific variable of interest, and JOIN-ing the record sets returned by successive queries. Such a sequence for implementing the equivalent of chained self-joins, applied to Table 1, is illustrated in Example E.1 (see also FIG. 2). In further embodiments, the self-join operation is generalized so as to combine record sets returned by queries directed to different tables.

### 2.2 Relationship Primitives

RelationshipPrimitives represent a fundamental set of relations of a hierarchically structured original data source, with reference to a pre-selected context node, in analogy to XPath axes, defined at developer.mozilla.org web site under/en-US/docs/Web/XPath/Axes.

In one embodiment of the GenericTabularRepresentation, query objects for the set of RelationshipPrimitives are constructed using the where-clause patterns in Table 2 (wherein supplemental constraints, such as those further described in Example E.2, are omitted for clarity). In other embodiments, as illustrated herein, query patterns may reference the selected context node by way of an instantiated in-clause.

TABLE 2

| Relationship | |
|---|---|
| Primitive | Function Expressions for Query Patterns |
| Self | const inClauseArg_Self = [ |
| | \grave{ }(x) => isEQ(x,′${cn.uniquePropPath}′)\grave{ } |
| | ]; |
| AncestorOrSelf | const inClauseArg_AncSelf = [ |
| | \grave{ }(x) => isPref(x,′${cn.uniquePropPath}′)\grave{ }, // Ancestor |
| | \grave{ }(x) => Number(x) <= ${cn.level}\grave{ } |
| | ]; |
| DescendantOrSelf | const inClauseArg_DescSelf = [ |
| | \grave{ }(x) => isPref(′${cn.uniquePropPath}′,x)\grave{ }, // Descendant |
| | \grave{ }(x) => Number(x) > = ${cn.level}\grave{ } |
| | ]; |
| Ancestor | const inClauseArg_Anc = [ |
| | \grave{ }(x) => isPref(x,′${cn.uniquePropPath}′)\grave{ }, // Ancestor |
| | \grave{ }(x) => Number(x) < ${cn.level}\grave{ } // exclude Self |
| | ]; |
| Descendant | const inClauseArg_Desc = [ |
| | \grave{ }(x) => isPref(′${cn.uniquePropPath}′,x)\grave{ }, // Descendant |
| | \grave{ }(x) => Number(x) > ${cn.level}\grave{ } // exclude Self |
| | ]; |
| Parent | const inClauseArg_Parent = [ |
| | \grave{ }(x) => isPref(x,′${cn.uniquePropPath}′)\grave{ }, // Descendant |
| | \grave{ }(x) => Number(x) = ${cn.level} − 1\grave{ } // |
| | ]; |
| Child | const inClauseArg_Child = [ |
| | \grave{ }(x) => isPref(′${cn.uniquePropPath}′,x)\grave{ }, // Descendant |
| | \grave{ }(x) => Number(x) = ${cn.level} + 1\grave{ } // |
| | ]; |
| Preceding | const inClauseArg_Prec = [ |
| | \grave{ }(x) => !isPref(x,′${cn.uniquePropPath}′)\grave{ }, // NOT Ancestor |
| | \grave{ }(x) => Number(x) < ${cn.recordNo}\grave{ } |
| | ]; |
| Following | const inClauseArg_Follw = [ |
| | \grave{ }(x) => !isPref(′${cn.uniquePropPath}′,x)\grave{ }, // NOT Ancestor |
| | \grave{ }(x) => Number(x) > ${cn.recordNo}\grave{ } |
| | ]; |
| PrecedingSibling | const q inClauseArg_PrecSib = [ |
| | \grave{ }(x) => x === ′${cn.parentRecordNo}′\grave{ }, // same parent |
| | \grave{ }(x) => Number(x) < ${cn.recordNo}\grave{ } |
| | ]; |
| FollowingSibling | const inClauseArg_FollwSib = [ |
| | \grave{ }(x) => x === ′${cn.parentRecordNo}′\grave{ }, // same parent |
| | \grave{ }(x) => Number(x) > ${cn.recordNo}\grave{ } |
| | ]; |

### 2.3 Named Pattern Groups

In one respect, the present invention discloses named groups of query patterns as a means for devising generalized parametrized queries, thereby further improving re-usability. For example, a grouping of the pattern combination in Query E2.2, for selecting the Ancestor set of a pre-selected context node (here denoted ‘cn’), may be named by a special key value-pair such as {“?”: “% rpExpr”}, wherein the special symbol ‘%’ indicates to the Interpreter to perform the requisite syntax expansion, as follows:

```
const rpAnc = [
  {″?″:″%rpExpr″}
  {″?uniquePropPath″:\grave{ }(x) => isPref(x,′${cn.uniquePropPath}′)\grave{ }},
  {″?level″:\grave{ }(x) => Number(x) < ${cn.level}\grave{ }}
];
```

### Similarly, for PrecedingSibling:

```
const rpPSib = [
  {″?″:″%rpExpr″},
  {″?parentRecordNo″:\grave{ }(x) => x === ′${cn.parentRecordNo}′\grave{ }},
  {″?recordNo″:\grave{ }(x) => Number(x) < ${cn.recordNo}\grave{ }}
];
```

In one respect, this array of objects is the analog of a (non-recursive) rule, wherein the first element represents (the analog of) the rule head, and the subsequent elements represent (the analog of) the rule body.

In a preferred embodiment, the complete set of RelationshipPrimitives is implemented by executing the single parametrized Query 2.3.1, providing to the QueryEvaluator the named pattern group of interest, from Table 2, as an argument to the in-clause.

Query 2.3.1

```
let prqGTR = {
  find:[″?recordNo″,″?parentRecordNo″,″?uniquePropPath″,″?propKey″],
  in: ″%rpExpr″,
  where: [
    {″?″:″%rpExpr″}
  ]
}
```

Execution of this query proceeds by: first, instantiating the in-clause, namely by instantiating ‘% rpExpr’; and next, instantiating the where-clause with reference to the instantiated in-clause.

### 2.4 Inferential Information Retrieval

The methods of the present invention provide the means of retrieving information in accordance with relations defined by the analog of rules.

### 2.4.1 Defined Relations

In preferred embodiments, new relations may be defined in terms of RelationshipPrimitives, by combining where- and whereNext-clauses in a self-referencing query. This is illustrated by Query E2.4 in Example E2.2 which retrieves the record set defined by SiblingOrSelf as the set of Child relations of the Parent of the selected context node, akin to navigating nodes in a hierarchical XML document using XPath expressions. This functionality corresponds to the application of a rule.

### 2.4.2 Recursively Defined Relations

The methods of the present invention further provide the means for retrieving record sets in accordance with recursive relations, such as Ancestor and Descendant, defined as follows: For All x,y,z under consideration, Parent (x, y) AND Ancestor (y, z)→Ancestor (x, z), where Ancestor (x,y)=Parent (x,y), and analogously for Descendant (Lecture Notes TU Dresden at iccl.inf.tu-dresden.de website under/w/images/b/b2 and further under/Lecture-12-datalog-introduction.pdf.)

Query 2.4.1 recursively retrieves the record set comprising nodes defined by the recursive Ancestor relation with reference to a pre-selected context node (‘cn’), namely by: specifying, in the where-clause, a query pattern to retrieve the Parent as the first Ancestor of cn and, in the rwhereNext-clause, a query pattern to recursively retrieve Parent of Parent . . . , wherein the templated PredicateExpression is instantiated anew in each cycle with the record returned by the previous cycle. The combination of where-clause and rwhereNext-clause thus implements the recursive definition of the Ancestor relation above in a manner equivalent to the application of a recursive rule.

Query 2.4.1

```
let rpqGTR_anc_opt_alt = {
  find: [″?recordNo″,″?parentRecordNo″,″?level″,″?leaf″,″?uniquePropPath″,
  ″?propKey″],
  in: [″?pRcNoExpr″],
  where: [ // Parent
    {″?recordNo″:″?pRcNoExpr″},
  ],
  rwhereNext: [ // recursive where clause: Parent of Parent of Parent ...
    {″?recordNo″:″(x) => isEQ(x,′_@w.parentRecordNo@_′)″},
  ],
  whereFurther: [
    {″?leaf″:″(x) => Number(x) === 0″}, // exclude leaves
    {″?recordNo″:″(x) => Number(x) > 0″}, // exclude root
    {″?propAttr″:″(x) => x === ′(null)′″} // exclude ′extra′ records
  ]
};
// usage
let qinArgs_Parent_alt = [
  ‘(x) => isEQ(x,′${cn.recordNo}′)‘ // reference context node via template literal
];
let rpqOutp = query(rpqGTR_anc_opt_alt, gtrTb, qinArgs_Parent_alt);
```

In accordance with the preferred execution model of the current invention, implemented in the Interpreter, execution of this query, illustrating several features of the query language of the present invention, proceeds as follows:
1—instantiate the in-clause, by substituting for “?pRcNoExpr” the content of qinArgs_Parent_alt, provided as an arg to the QueryEvaluator—
2—instantiate the where-clause (notably “?pRcNoExpr”) by referencing the instantiated in-clause;
3-execute the where-clause to obtain the Parent of the context node and store in an (‘accumulator’) array;
4-recursively:
   instantiate the rwhereNext-clause by referencing the ‘parent’ record set returned by the preceding where-clause;
   execute the where-clause, now instantiated by referencing the rwhereNext-clause and add this to the accumulator;
   stop when execution of the where-clause returns an empty record set;
5—to the record set available after completion of step 4, apply auxiliary patterns by executing the whereFurther-clause;
6—filter the record set to select items specified in the find-clause replace keys by aliases, as specified by the substring following ‘_AS_’;

Executing this query, for the context node selected above, retrieves the same record set of 10 ancestors returned, without invoking recursion, by Query E2.2, namely: recordNo= [539, 533, 529, 528, 519, 517,378, 375, 154, 148, 1]. While the query patterns in Query E2.2 specify constraints on absolute node paths, encoded in the form of uniquePropPath as well as node level, to retrieve Ancestors non-recursively, the recursive Query 2.4.1 prescribes the traversal of nodes by concatenating relative node paths, specified by recordNo and parentRecordNo only.

Descendants (that is: the record set comprising nodes defined by the Descendant relation) of the pre-selected context node (‘cn’) are recursively retrieved by Query 2.4.2, specifying query patterns, in where- and rwhereNext-clauses, to select, respectively: the Child of cn, then recursively Child of Child of Child . . .

Query 2.4.2

```
let rpqGTR_desc_opt_alt = {
  find: [″?recordNo″,″?parentRecordNo″,″?level″,″?leaf″,″?uniquePropPath″,
″?propKey″],
  in: [″?pRcNoExpr″],
  where: [ // Child
    {″?parentRecordNo″:″?pRcNoExpr″}
  ],
  rwhereNext: [ // recursive where clause: Child of Child . . .
    {″?parentRecordNo″:″(x) => isEQ(x,′_@w.recordNo@_′)″},
  ],
  whereFurther: [
    {″?leaf″:″(x) => Number(x) === 0″},
    {″?propAttr″:″(x) => x === ′(null)′″}
  ]
}
// usage
let qinArgs_Child_alt = [
  ‘(x) => isEQ(x,′${cn.recordNo}′)‘
];
let rpqOutp =queryGTR(rpqGTR_desc_opt_alt, gtrTb, qinArgs_Child_alt);
```

Executing this query retrieves a record set of 43 descendants of the context node specified above.

### 3—Method Interface: Constructors for Queries, Query Sequences & Joins

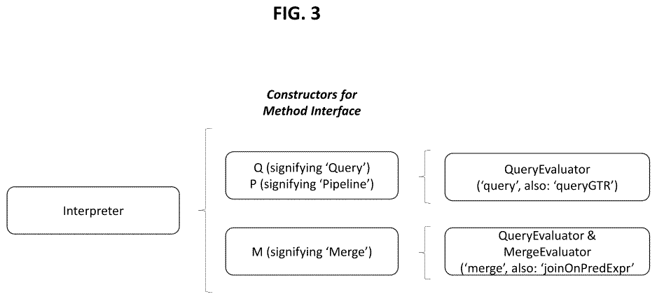

The query language of the invention further comprises collections of methods and functions, also referred to herein as a method interface, that enhances the expressivity and hence the utility of the language, while providing a transparent syntax for constructing complex queries, query sequences and joins. FIG. 3 gives a summary overview of the constructors provided in the method interface and its dependencies on the QueryEvaluator and MergeEvaluator, further described in this section.

In a preferred embodiment of the query language of the invention, and described in Sect. 3.1, query objects are created and optionally executed by way of a query constructor having methods comprising: a first collection of methods for creating query clauses, notably those of Sect. 1, and a Run method for invoking the QueryEvaluator; as described, this and related methods also facilitate the nesting and the sequencing of queries to form transformation pipelines, as described in Sect. 3.2. The functionality of the method interface augmented is augmented by a second, extensible collection of methods for invoking anonymous or named query factories, as described in Sect. 3.3, including: Lambda & LambdaNext methods for invoking anonymous query factories; Call & CallNext methods for invoking named query factories; and named special methods defined on the query constructor that are convenient for invoking recurring named query factories. Further, as described in Sect. 3.4, constructors and constituent methods are provided for creating and executing pairwise join operations, notably including to self-joins, which may be chained, as illustrated for chained self-joins in Example E.3.

### 3.1 Query Constructor & Core Methods for Creating Query Clauses

In a preferred embodiment, a query object of the invention is created by invoking a query constructor, Q, with methods for creating query clauses, as in Box 3.1.1:

Box 3.1.1 Query constructor Q( ) and Clause method

```
export function Q( ) {
}
Q.prototype.Clause = function(clause, clauseArgs) {
  if(Array.isArray(clauseArgs) && clauseArgs.length > 0) {
    this[clause] = [];
    clauseArgs.map(e => this[clause].push(e));
  } else {
    console.log(′ ... ERROR: invalid >>${clause} << arg: ${clauseArgs}′ );
    throw new Error( );
  }
  return this;
}
// example: method for creating 'find' clause
Q.prototype.Find = function(clauseArgs) {
    this.Clause(′find′, clauseArgs);
    return this;
}
```

Each of this first collection of methods defined on the constructor, also referred to herein as ‘core methods’, relates to one of the query clauses introduced in Sect. 1 including Find, In, Where, WhereFurther, WhereNext, WhereNextRc, Update and Method, wherein, in a preferred embodiment, invoking a method creates an eponymous query clause, wherein the method name is capitalized, as in the Find method of Box 3.1.1 for creating the find clause.

These methods preferably are defined by invoking a generic Clause method, wherein each method preferably is named by capitalizing the corresponding query clause. The Clause method preferably is defined by way of a function that accepts as first argument the name of the intended query clause and accepts any further arguments relating to that clause, as in Box 3.1.1. Invoking the constructor with any such method creates the corresponding query clause in the new query object using the argument(s) provided to the method.

In a preferred embodiment, the constructor is invoked via the keyword new to ensure the creation of the this keyword, which here refers to the query object being created (developer.mozilla.org under/en-US/docs/Web/JavaScript/Reference/Operators/new. Returning this enables method chaining, as illustrated in Query 3.1.1:

Query 3.1.1

```
Let qOutp = new Q( )
  .Find( [″?recordNo″, ″?uniquePropPath″,″?propKey″,″?annotation″] )
  .Update( [{″?propKey″:[″X″,″XX″]},{″?annotation″:[″,′description′]}] )
  .In( [″?uppExpr″,″?lvExpr″] )
  .Where( [{″?uniquePropPath″:″?uppExpr″}, {″?level″:″?lvExpr″}] )
```

Update Method—The Update clause in Query 3.1.1 instructs the QueryEvaluator to replace any matching propKey value ‘X’ by ‘XX’ and to add an annotation column, to be populated with the text ‘description’. As shown, Update (in contrast to the semantics of the eponymous SQL command) typically is used in conjunction with the Find clause to display the updated data collection, as shown here.

### 3.2 Methods for Invoking the QueryEvaluator

Run Method—Also defined is a Run method, as in Box 3.2.1 to invoke the QueryEvaluator, by way of the function query, elsewhere also referred to as queryGTR.

Box 3.2.1: Run Method

Q.prototype.Run = function(tb, qinArgs=null) {
return query(this, tb, qinArgs);
}

The integration of creating queries and executing them by invoking the Run method is illustrated in Query 3.2.1A for a parametrized query that returns the ancestor relations of a specified context node, cn, in a given data collection, gtrTb:

Query 3.2.1A

```
const qinArgs = [ // specify 'Ancestor'
    `(x) => isPref(x,'${cn.uniquePropPath}')',
    `(x) => Number(x) < ${cn.level}
];
let qOutp = new Q( )
  .Find( [″?recordNo AS recNo″, ″?uniquePropPath AS uPP″,
″?propKey″] )
  .In( [″?uppExpr″, ″?lvExpr″] )
  .Where( [{″?uniquePropPath″:″?uppExpr″}, {″?level″:″?lvExpr″}] )
  .Run(gtrTb, qinArgs);
```

This is equivalent to invoking the following query created as an object literal, as in Sect. 1:

Query 3.2.1B

```
// define query object
Let qGTR = {
  find: [″?recordNo″,″?uniquePropPath″, ″?propKey″],
  in: [″?uppExpr″,″?lvExpr″],
  where: [ {″?uniquePropPath″:″?uppExpr″},
    {″?level″:″?lvExpr″} ]
// usage
Let qOutp = queryGTR(qGTR,gtrTb,qinArgs));
```

### 3.2.1 Nested Queries

In one embodiment, the Run method accommodates nested queries, as follows:

Query 3.2.2

```
let nested QueryOutp = new Q( )
  .Find([″?parentRecordNo″,″?prop Val_AS_id″])
  .Where([{″?propKey″:″(x) => x === 'Label″'}])
  .Run(new Q ()
    Find([″ ?* ″])
    .Where([{″?level″:″(x) => x >= 1″}])
    .Run(gtrTb)
  )
// usage
console.log(″\n ... nested query:', nestedQueryOutp);
```

### 3.2.2 Query Sequences: Transformation Pipelines

Workflows (aka ‘pipelines’) for processing and analyzing data often require successive transformations of query outputs in accordance with downstream requirements, including but not limited to: filtering, aggregating or reformatting (aka ‘re-shaping’). Accordingly, the introduction of a pipeline constructor, P, offers a convenient way to devise and execute query sequences, including but not limited to sequences of sourcing and transforming queries, also referred to herein as transformation pipelines. In its simplest form, the pipeline constructor has the named special methods, as follows:

Box 3.2.2: Pipeline constructor & related methods

```
export function P( ) {
}
P.prototype.SrcQ = function(q, tb, qinArgs=null) { // q = sourcing query
  this.qOutp = query(q, tb, qinArgs);
  return this;
}
P.prototype.TxnQ = function(q, qinArgs=null) { // q = transforming query
  this.qOutp = query(q, this.qOutp, qinArgs);
  return this;
}
```

The SrcQ method executes a sourcing query that is directed to a data collection of interest, here named tb, while the TxnQ method executes a transforming query that operates on the output of the sourcing query or that of a immediately preceding transformation query. Both methods accept as an argument a query object, preferably created by invoking the query constructor; alternatively, query objects may be created by way of an anonymous or named query factory, as described in greater detail below, and they both invoke the QueryEvaluator, here named query, as illustrated in Query 3.2.2.

### 3.3 Methods for Invoking Anonymous or Named Query Factories

The expressivity and hence the utility of the method interface of the invention, and the transparency of its syntax, are considerably enhanced by providing methods providing a further level of abstraction, namely the creation and invocation of queries by way of anonymous or named query factories. A query factory herein is a function for creating a query object, preferably by invoking the query constructor, executing the query by invoking the QueryEvaluator, and returning the query output.

### 3.3.1 Anonymous Query Factories: Lambda & LambdaNext Methods

In one embodiment, convenient especially for accommodating ‘one-off’ special queries, the query constructor provides the special methods Lambda and LambdaNext for defining and invoking an anonymous query factory. The Lambda method is defined as follows:

Box 3.3.1

```
Q.prototype.Lambda = function(fn) {
  if(typeof fn !== 'function') {
    console.log( ′... ERROR: >>${fn} << must be a function′);
    throw new Error( );
  }
  this.qOutp = fn( );
  return this;
}
```

Query 3.3.1A illustrates the use of these methods for navigating a RelationalDataStore conforming to the GenericTabularRepresentation, namely by selecting a context node and retrieving its parent record.

Query 3.3.1A: Selecting ContextNode by uPP via Lambda Method

```
new Q( )
.Lambda( (uPP='.0-15.1-17',tb=gtrTb) => {
  return new Q( )
    .Find([″ ?* ″])
    .Where([{″?uniquePropPath″:`(x) => isEQ(x,'${uPP}') }])
    .Run(tb);
  })
```

Query 3.3.1B illustrates the chaining of anonymous query patterns for navigating a RelationalDataStore conforming to the GenericTabularRepresentation, namely by selecting a context node, as in Query 3.3.1A, and retrieving its parent record.

Query 3.3.1B: Chaining of Anonymous Query Patterns via Lambda & LambdaNext

```
new Q( )
.Lambda( (uPP='.0-15.1-17',tb=gtrTb) => { // select cn by uPP
  return new Q( )
    .Find([″ ?* ″])
    .Where([{″?uniquePropPath″: (x) => isEQ(x,'${uPP}') }])
    .Run(tb);
})
.LambdaNext( (cn) => (tb=gtrTb) => { // curried fn for 'parent' - to follow Lambda
  const qinArgsParent = [
    `(x) => isPref(x,'${cn.uniquePropPath}')',
    `(x) => Number(x) === ${cn.level}-1`,
  ];
  return new Q( )
    .Find( [″?recordNo″, ″?level″, ″?leaf″, ″?uniquePropPath″,
″?propKey″] )
    .In( [″?uppExpr″,″?lvExpr″] )
    .Where( [
      {″?uniquePropPath″:″?uppExpr″},
      {″?level″:″?lvExpr″}] )
    .WhereFurther( [ // to remove spurious records
      {″?propAttr″:″(x) => x === '(null)' || x === ″ || x === null″}] )
    .Run(db, qinArgs_Parent);
})
.ShowQuery Res( )
```

Chaining of query factories provides a preferable alternative to the often less transparent nesting of queries which otherwise may be called for in these situations. Chaining of course presumes consistent signatures of the functions in successive LambdaNext invocations.

A technical point of note is this: to preserve the context of ‘this’, created when invoking the query constructor via Lambda, the anonymous function invoked by the subsequent LambdaNext method is partially applied by way of currying (javascript.info web site under currying-partials). This is indicated by a related comment in preceding Query 3.3.1B.

### 3.3.2 Named Query Factories

The creation and usage of named query factories may be illustrated by implementing RelationshipPrimitives for navigating a RelationalDataStore conforming to GenericTabularRepresentation, previously described in Sect 2.2 are shown in the following queries, namely: Query 3.3.2 for implementing a ‘contains’ function:

Query 3.3.2: Query factory implementing the contains function

```
const contains = (propKey Val, propAttr Val, db, DEBUG=false) => {
  const qGTR = new Q( )
    .Find([″?parentRecordNo″])
    .Where([ {″?propKey″:'(x) => isEQ(x, '${propKeyVal}') },
      {″?propAttr″:'(x) => isEQ(x, '${propAttr Val}') } ]);
  return queryGTR(qGTR, db, false);
}
```

And in the related Queries 3.3.3A & B two versions of a selectContextNode function:

Query 3.3.3A: Query Factory implementing selectContextNodebyAttr

```
// return query object identifying context node by constituent attribute, via 'contains'
export const selectContextNodeByAttr = (propKey Val, propAttr Val, db) => {
  const cnAttr = contains(propKey Val, propAttr Val, db);
  const qGTR = new Q( )
    .Find([″ ?* ″])
    .Where([{″?recordNo″:`(x) => isEQ(Number(x),
${cnAttr.parentRecordNo}) }]);
  return queryGTR(qGTR, db);
}
```

Query 3.3.3B: Query Factory implementing selectContextNode via uniquePropPath

```
// return query object identifying context node by uniquePropPath, uPP
export const selectContextNode = (uPP, tb) => {
  const qGTR = new Q( )
    .Find([″ ?* ″])
    .Where([{″?uniquePropPath″: (x) => isEQ(x, '${uPP}') }]);
  return queryGTR(qGTR, tb);
}
```

Query factories returning query objects for identifying self and ancestor relations for that context node are shown in Query 3.3.4A &B, respectively; analogous query factories may be defined for other RelationshipPrimitives.

Query 3.3.4A

```
export const self = (cn, tb) => { // cn refers to ′context node′
  const qinArgs = [ // using 2 args to be able to use the same param query
    `(x) => isEQ(x,′${cn.uniquePropPath}′)′,
    `(x) => isEQ(x,′${cn.level}′)′
  ];
  const qGTR = new Q( )
    .Find([″?*″])
    .In([″?uppExpr″,″?lvExpr″])
    .Where([ {″?uniquePropPath″:″?uppExpr″},
{″?level″:″?lvExpr″} ]);
  return queryGTR(qGTR, tb, qinArgs);
}
```

Query 3.3.4B

```
export const ancestor = (cn, db) => {
  const qinArgs = [
      `(x) => isPref(x,′${cn.uniquePropPath′)′, // ancestor
      `(x) => Number(x) < ${cn.level}″ // to include ′self′, replace ′<′ by ′<=′
  ];
  const qGTR = new Q( )
    .Find([″?recordNo″,″?level″,″?leaf″,″?uniquePropPath″,″?propKey″])
    .In([″?uppExpr″,″?lvExpr″])
    .Where([
      {″?uniquePropPath″:″?uppExpr″},
      {″?level″:″?lvExpr″}
    ])
    .WhereFurther([
      {″?leaf″:″(x) => Number(x) === 0″}, // exclude leaves
      {″?recordNo″:″(x) => Number(x) > 0″}, // exclude root
      {″?propAttr″:″(x) => x === ′(null)′ || x === ″ || x === null″}
    ]);
  return queryGTR(qGTR,db,qinArgs,false);
}
```

### 3.3.2.1 Function Dispatch for Named Query Factories

In a preferred embodiment, query factories are rendered invocable by name by entering (‘registering’) them in a function dispatch object, here named qfnDispatch. This is illustrated in Box 3.3.2 for a collection of query factories implementing RelationshipPrimitives described in Sect. 2.2, as well as a query factory for selecting a context node, described above.

Box 3.3.2

```
const createFunctionDisp = (objArr) => Object.assign(...objArr);
// place all fn′s to be invoked by name into this object
    export const qfnDisp = createFunctionDisp( [
    selectContextNode, selectContextNodeByAttr,
    self, ancestorOrSelf, descendantOrSelf,
    ancestor, descendant, parent,child,
    preceding, following, precedingSib, followingSib ]
);
```

### 3.3.2.2 Invoking Named Query Factories: Call & CallNext Methods

In one embodiment, registered functions are invoked by way of the general-purpose methods Call and CallNext, defined as shown in Boxes 3.3.3A & B, respectively.

Box 3.3.3A

```
Q.prototype.Call = function(fn, ... args) {
  if(typeof fn !== ′string′) {
    console.log(′... ERROR: >>${fn} << must be a string giving fn name′);
    throw new Error( );
  }
  this.qOutp = qfnDisp[fn](...args);
  return this;
}
```

Box 3.3.3B

```
Q.prototype. CallNext = function(fn, ... args) { // to follow .Call
  if(typeof fn !== ′string′) {
    console.log(...ERROR: >>${fn} << must be a string giving fn name′);
    throw new Error( );
  }
  this.qOutp = qfnDisp[fn](this.qOutp, ... args); // partial fn app via currying
  return this;
}
```

As with the Lambda and LambdaNext methods for invoking anonymous query factories, the combination of Call and CallNext methods facilitates the chaining of named query factories, obviating the often less transparent nesting of queries, where, once again, chaining presumes consistent signatures of the functions in successive CallNext invocations. Using these methods, a chained sequence of relationship primitives takes the simple form shown in Query 3.3.5:

Query 3.3.5

```
new Q( )
  .Call(′selectContextNode′,′.0-15.1-17′,gtrTb)
  .CallNext(′parent′,gtrTb)
  .CallNext(′child′,gtrTb)
```

Generalized Call & CallNext Methods—In one embodiment, suitably generalized version of the Call and CallNext methods accommodate both registered as well as anonymous (and thus unregistered) query factories of the type accommodated above via the Lambda and LambdaNext methods.

### 3.3.2.3 Invoking Named Query Factories: Named Methods

In a further embodiment, registered factory functions implementing recurring named query factories are assigned named methods that are defined on the query constructor as shown in Box 3.3.4 for several examples of RelationshipPrimitives and related functions for selecting a context node.

Box 3.3.4

```
Q.prototype.SelectContextNode = function(tb,uPP) {
  this.qOutp = qfnDisp[′selectContextNode′](uPP,tb);
  return this;
}
Q.prototype.SelectContextNodeByAttr = function(tb,propKey,prop Val) {
  this.qOutp = qfnDisp[′selectContextNodeByAttr′](propKey,prop Val,tb);
  return this;
}
Q.prototype.Ancestor = function(tb) {
  this.qOutp = qfnDisp[′ancestor′](this.qOutp,tb);
  return this;
}
. . .
```

An application of these special methods facilitating the chaining of relationship primitives is illustrated in Query 3.3.6: given a context node, here selected by specifying a value of the uniquePropertyPath (‘uPP’), this sequence first identifies the parent of that context node, and then the child relations of that parent in the RelationalDataStore ‘gtrTb’—this abstraction substantially enhances the transparency of query syntax in comparison to that of Queries 3.3.1B (representing only the first two steps of this chain) and even that of Query 3.3.5:

Query 3.2.6: Chaining of RelationshipPrimitives via named special methods

```
new Q( )
  .SelectContextNode(gtrTb,uPP=′.0-15.1-17′)
  .Parent(gtrTb)
  .Child(gtrTb)
```

Proceeding analogously, other special methods may be defined, for example to extend the functionality of relationship primitives by introducing analogs of XPath functions developer.mozilla.org/en-US/docs/Web/under XPath/Functions in addition to contains, or to implement any other recurring query pattern of interest.

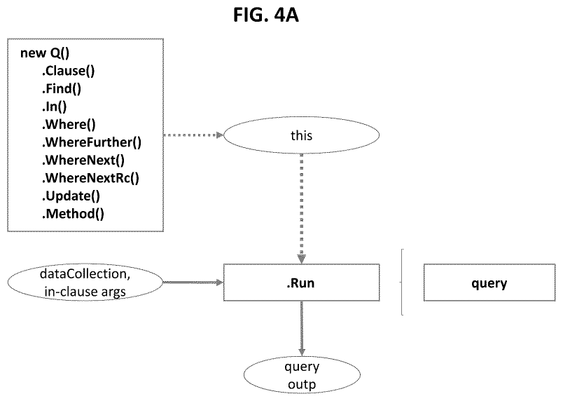

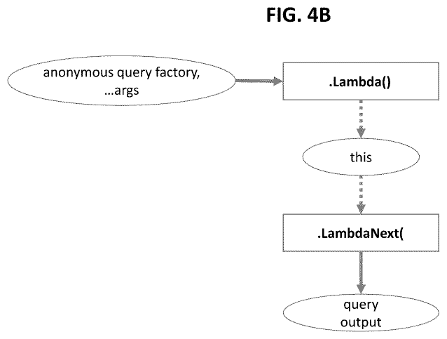

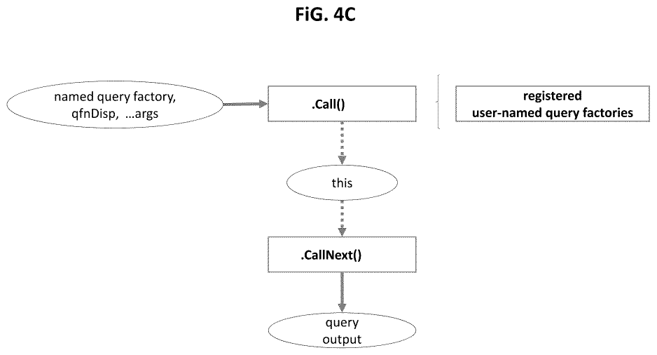

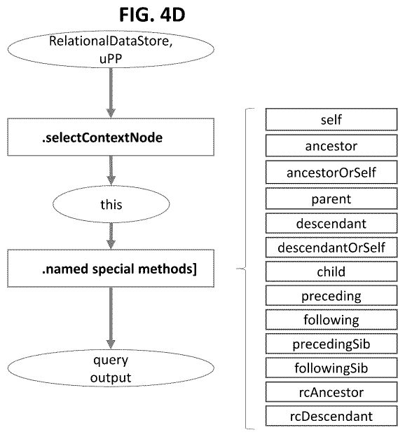

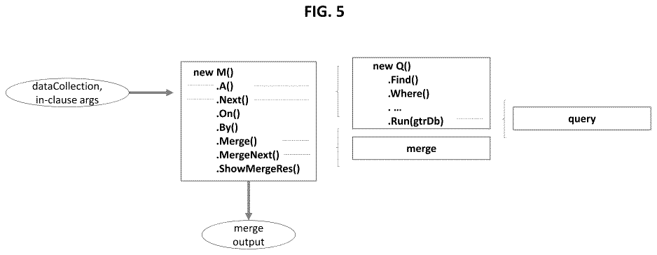

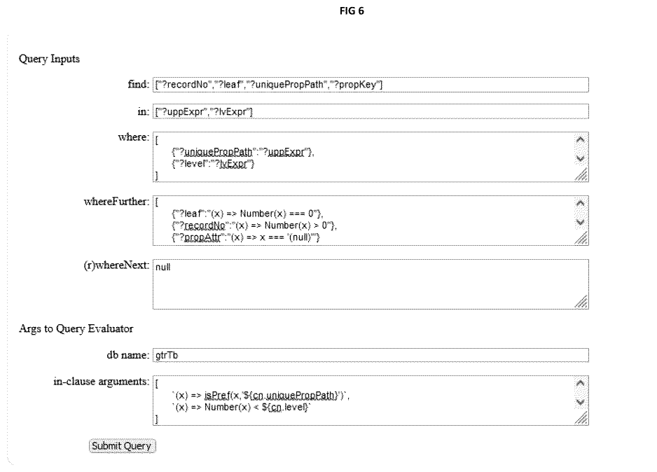

FIG. 4 gives a graphical summary of the query constructor core and its special and anonymous methods described in the preceding sections.

### 3.4 Merge Constructor & Core Methods for Implementing Joins & Self-Joins

To implement joins including chained joins, the method interface of the present invention further provides a merge constructor, M, with at least the collection of methods in Box 3.4.1 and FIG. 5.

Box 3.4.1

```
export function M( ) {
}
M.prototype.Clause = Q.prototype.Clause;
M.prototype.A = function(clauseArgs) {
  this.Clause(′a′, clauseArgs);
  return this;
}
M.prototype.Next = function(clauseArgs) {
  this.Clause(′next′,clauseArgs);
  return this;
}
M.prototype.On = function(clauseArgs, clause=′on′) {
  this.Clause(clause, clauseArgs);
  return this;
}
M.prototype.By = function(byArg=′inner′, clause=′by′) {
  this[clause] = byArg;
  return this;
}
M.prototype.Merge = function( ) { // pairwise merge
  this.mergeOutp = merge(this.a, this.b, this.on[0], this.by);
  return this;
}
M.prototype.MergeNext = function( ) { // overwrites output of preceding
merge step
  this.mergeOutp = merge(this.mergeOutp, this.next, this.onNext[0],
  this.byNext);
  return this;
}
M.prototype.ShowMergeRes = function( ) { // use last
  return this.mergeOutp;
}
```

Here, the Clause method is that previously defined for the query constructor and shown in Box 3.1.1; merge is an alias of joinOnExpr ( ) a function of the Interpreter that implements a pairwise join, and is explicitly invoked as part of the chained self-join in Sect 2.1,

### 3.4.1 Pairwise Join via Merge Constructor

The implementation of a pairwise join via the merge constructor is illustrated in Query 3.4.1, which here is placed into a factory function, named ‘pwJoin’, in a manner analogous to the query factories described in Sect 3.3 for the query constructor.

Query 3.4.1

```
export const pwJoin = (tb_head, tb_tail) => {
  return new M( )
  .A(new Q( )
    .Find([″?parentRecordNo″,″?prop Val_AS_id″])
    .Where([{″?propKey″:″(x) => x === ′id′′}])
    Run(tb_head))
  .Next(new Q( )
    .Find([″?uniquePropPath″,″?prop Val_AS_gSyntax″])
    .Where([{″?propKey″:″(x) => x === ′gSyntax′′′}])
    .Run(tb_tail))
  .On([″(e1,e2) => isSubStr(′4-′.concat(e1.parentRecordNo),e2.
  uniquePropPath)″])
  .By(′inner′,′by′)
  .Merge( )
  .Show MergeRes( )
}
```

As with the pipeline constructor of Sect, 3.2.2, the methods A & Next defined on the M constructor each in turn invoke methods defined on the Q constructor to create and execute, respectively, an ‘anchor’ and a ‘next’ query, directed to different RelationalDataStores. The On method specifies (in this case) a single PredicateExpression to be applied to pairs of records in the record sets returned by the two queries. Finally, the By method specifies the type of join, in this case ‘inner’, while accommodating other specifications such as ‘left’. For convenience, the two RelationalDataStores referenced in Query 3.4.1 were created by extracting from Table 1, comprising a total of 2,265 records, two overlapping sub-tables, the first, here named ‘tb_head’ comprising records 0 to 2,265-600, the second, here named ‘tb_tail’, comprising records 600 to 2,265 (where the value 600 has no particular significance other than to ensure overlap).

Execution of the first query returns a first array of objects, each having the keys ‘parentRecordNo’ and ‘id’, the second query returns a second array of objects, each having the keys ‘uniquePropPath’ and ‘gSyntax’, and the inner join yields an array of 9 objects, each having records with all four keys; for comparison, the self-join, with two identical copies of the full table (corresponding to complete overlap), yields 14 records; converted to csv format, this corresponds to a wide table sharing with Table E.1.1 in Example E.1 the column ‘id’ and ‘gSyntax’.

### 3.4.2 Chaining Joins

Joins, including self-joins, may be chained by invoking, in addition to the Merge method, the MergeNext method; as per the definitions in Box 3.4.1, while both methods invoke the MergeEvaluator, albeit with different arguments, they are provided for clarity and convenience to distinguish performing a pairwise join from chaining joins. In an alternative embodiment, these methods optionally are replaced by a single, suitably generalized Merge method handling both situations. Example E.4 gives the implementation of the chained self-join previously described in Sect 2.1 and Example E.1, illustrating that the method interface of the present invention provides an intuitive and transparent embodiment for creating and executing chained joins.

### 4-Implementation & Deployment

In a preferred embodiment wherein the Interpreter is a JavaScript program, the query language of the present invention can be deployed in any environment supporting JavaScript, including but not limited to nodeJS or other run-time environments, or in a web browser.

Local—In one embodiment, the query language of the invention is deployed locally, as part of a JavaScript application, preferably by importing the requisite modules implementing the QueryEvaluator and related functionality.

As-a-Service—In another embodiment, the query language is invoked as a service, by converting the query object to JSON and transmitting it to a server by way of an API request, wherein the server preferably also hosts the data collection of interest. Upon query execution, the query output is returned to the local application.

### 4.1 Interactive Query Interface

In one embodiment, the query object is interactively created, or modified, and submitted to the QueryEvaluator by way of a web form, as illustrated in FIG. 6 for Query E2.2. Upon submission of the form, JavaScript code within a script block of the HTML mark-up collects data from the form and assembles the query object, preferably by invoking the functionality for dynamic query assembly disclosed in Sect. 1.3, and invokes the QueryEvaluator. Query output may be displayed in HTML, preferably in a separate window, or otherwise processed. Similarly, a form also may be implemented as a local client, for example as a Microsoft Windows form.

### 4.2 Method Interface

In a preferred embodiment, wherein the language of the Interpreter of the invention is Javascript, the implementation of the method interface, in the interest of conceptual clarity, explicitly invokes the prototypal inheritance of that language, as in Sect. 3 and the related Example E.3. An alternative embodiment of the method interface may invoke the ‘class’ syntax also available in recent versions of Javascript (developer.mozilla.org web site under/en-US/docs/Web/JavaScript/Reference/Classes). In other embodiments of the Interpreter, wherein the implementation language supports class inheritance, a method interface may be created by defining methods on classes and constructing the desired objects as class instances (en.wikipedia.org web site under/wiki/Inheritance_(object-oriented programming)).

### EXAMPLES

### E.1 Tabular Display of User-Selected Content: Chained Self-Joins

The SQL Query E1.1 of chained self-joins, applied to the (complete) data set of Table 1 (referred to in the query as ‘theTable’) returns the Table E.1.1 of 14 records, below, with columns named in accordance with the aliases specified in the SELECT clause.

Query E1.1 (SQL)

```
SELECT
      a.propVal AS id,
      g.propVal AS GeneSymbol,
      b.propVal AS gSyntax,
      c.propVal AS pSyntax,
      d.propVal AS transcSyntax
FROM theTable a
JOIN theTable b
ON INSTR(b.uniquePropPath,(′4-′ ∥ a.parentRecordNo)) > 0
    AND a.propKey = ′id′ AND b.propKey = ′gSyntax′
LEFT JOIN theTable c
ON INSTR(c.uniquePropPath,(′4-′ ∥ a.parentRecordNo)) > 0
    AND a.propKey = ′id′ AND c.propKey = ′pSyntax′ AND INSTR(c.propPath,′cSyntaxes[0]′) > 0
JOIN theTable d
ON INSTR(d.uniquePropPath,(′4-′ ∥ a.parentRecordNo)) > 0
    AND a.propKey = ′id′ AND d.propKey = ′transcSyntax′ AND INSTR(d.propPath,′cSyntaxes[0]′)
> 0
JOIN theTable g
ON INSTR(g.uniquePropPath, (′4-′ ∥ a.parentRecordNo)) > 0
    AND a.propKey = ′id′ AND g.propKey = ′symbol′ AND INSTR(g.propPath, ′cSyntaxes[0]′) > 0
```

TABLE E.1.1

| id | GeneSymbol | gSyntax | pSyntax | transcSyntax |
|---|---|---|---|---|
| 153969_6836247147610989546_0_0_196 | MSH2 | chr2: g.47702190_ | NP_000242.1: p.N596* | NM_000251.2: c.1786_ |
| | | 47702191delAA | | 1787delAA |
| 153969_6836247147610989546_0_0_306 | FBXW7 | chr4: g.153245402C > T | NP_001013433.1: p.G479R | NM_001013415.1: |
| | | | | c.1435G > A |
| 153969_6836247147610989546_0_0_313 | TERT | chr5: g.1295250G > A | (null) | NM_198253.2: c.-146C > T |
| 153969_6836247147610989546_0_0_467 | SMO | chr7: g.128845452C > A | NP_005622.1: p.A250D | NM_005631.4: c.749C > A |
| 153969_6836247147610989546_0_0_590 | CDKN2A | chr9: g.21971108C > T | NP_000068.1: p.D84N | NM_000077.4: c.250G > A |
| 153969_6836247147610989546_0_0_638 | TSC1 | chr9: g.135781059_ | NP_000359.1: p.E636Gfs*51 | NM_000368.4: c.1907_ |
| | | 135781060delCT | | 1908delAG |
| 153969_6836247147610989546_0_0_752 | ATM | chr11: g.108175490T > C | NP_000042.3: p.L1862P | NM_000051.3: c.5585T > C |
| 153969_6836247147610989546_0_0_913 | TSC2 | chr16: g.2137930C > T | NP_000539.2: p.Q1686* | NM_000548.3: c.5056C > T |
| 153969_6836247147610989546_0_0_912 | TSC2 | chr16: g.2129303C > T | NP_000539.2: p.A1053V | NM_000548.3: c.3158C > T |
| 153969_6836247147610989546_0_0_1049 | TP53 | chr17: g.7577120C > T | NP_000537.3: p.R273H | NM_000546.5: c.818G > A |
| 153969_6836247147610989546_0_0_1050 | TP53 | chr17: g.7578223_ | NP_000537.3: p.R209Kfs*6 | NM_000546.5: c.626_ |
| | | 7578224delCT | | 627delGA |
| 153969_6836247147610989546_0_0_1078 | NF1 | chr17: g.29527503_ | NP_000258.1: p.E318Kfs*11 | NM_000267.3: c.952_ |
| | | 29527504delGA | | 953delGA |
| 153969_6836247147610989546_0_0_1104 | ERBB2 | chr17: g.37872099C > A | NP_001005862.1: p.L444I | NM_001005862.1: |
| | | | | c.1330C > A |
| 153969_6836247147610989546_0_0_1220 | GNAS | chr20: g.57484420C > T | NP_000507.1: p.R201C | NM_000516.4: c.601C > T |

By the methods of the present invention, the record set in this table is generated by devising a query sequence, also referred to herein as a workflow, that replicates the chained self-join sequence of SQL Query E1.1 (‘SQL’), in this Section above. This workflow comprises an alternating sequence of executing queries and JOIN operations, wherein the function implementing the JOIN accepts a first and a second record set, a Predicate Expression, and an optional string indicating the type of JOIN to be performed, the latter by default having a value of ‘inner’. With the letter notation of the SQL query, the requisite sequence, in one embodiment, comprises a set of simple queries, as follows:

Query E1.2

```
let qGTR_a = {
  find: [″?parentRecordNo″,″?propVal_AS_id″],
  where: [
    {″?propKey″:″(x) => x === ′id′′′}
  ],
  whereFurther: [
    {″?parentRecordNo″:″(x) => Number(x) >= 0″}
  ]
}
let qGTR_b = {
  find: [″?uniquePropPath″,″?propVal_AS_gSyntax″],
  where: [
    {″?propKey″:″(x) => x === ′gSyntax′′′}
  ]
}
let qGTR_c = {
  find: [″?uniquePropPath″,″?propVal_AS_pSyntax″],
  where: [
    {″?propKey″:″(x) => x === ′pSyntax′′′},
    {″?propPath″:″(x) => x.includes(′cSyntaxes[0]′)″}
  ]
}
let qGTR_d = {
  find: [″?uniquePropPath″,″?propVal_AS_transcSyntax″],
  where: [
    {″?propKey″:″(x) => x === ′transcSyntax′′′},
    {″?propPath″:″(x) => x.includes(′cSyntaxes[0]′)″}
  ]
}
let qGTR_g = {
  find: [″?uniquePropPath″,″?propVal_AS_GeneSymbol″],
  where: [
    {″?propKey″:″(x) => x === ′symbol′′′},
    {″?propPath″:″(x) => x.includes(′cSyntaxes[0]′)′′}
  ]
}
```

Each of these queries extracts a record set, with propKey constrained to one of the variables of interest, namely those identified in the SELECT clause of the SQL query: id, gSyntax, pSyntax, transcSyntax and symbol.

In the transformation workflow, successive JOINs accumulate the query outputs, as follows:

```
let a = queryGTR(qGTR_a, gtrTb);
let ab = joinOnPredExpr(a, queryGTR(qGTR_b, gtrTb),
  ″(e1,e2) => isPref(′4-′.concat(e1.parentRecordNo),e2.uniquePropPath)″)
let abc = joinOnPredExpr(ab, queryGTR(qGTR_c, gtrTb),
  ″(e1,e2) => isPref(′4-′.concat(e1.parentRecordNo),e2.uniquePropPath)″,″left″)
let abcd = joinOnPredExpr(abc, queryGTR(qGTR_d, gtrTb),
  ″(e1,e2) => isPref(′4-′.concat(e1.parentRecordNo),e2.uniquePropPath)″)
let abcdg = joinOnPredExpr(abcd, queryGTR(qGTR_g, gtrTb),
  ″(e1,e2) => isPref(′4-′.concat(e1.parentRecordNo),e2.uniquePropPath)″)
```

The record set ‘abcdg’ returned by this workflow is an array of 14 objects, wherein each object comprises the desired entries, as follows (showing only the first and last records):

```
[
  {
    parentRecordNo: ′46402′,
    id: ′153969_6836247147610989546_0_0_196′,
    uniquePropPath: ′.0-0.1-5.2-46399.3-46401.4-46402.5-46404.6-46405.7-46406.8-46408.9-
46409′,
    gSyntax: ′chr2:g.47702190_47702191delAA′,
    pSyntax: ′NP_000242.1:p.N596*′,
    transcSyntax: ′NM_000251.2:c.1786_1787delAA′,
    GeneSymbol: ′MSH2′
  },
...
  {
    parentRecordNo: ′163330′,
    id: ′153969_6836247147610989546_0_0_1220′,
    uniquePropPath: ′.0-0.1-5.2-46399.3-46401.4-163330.5-163332.6-163333.7-163334.8-
163336.9-163337′,
    gSyntax: ′chr20:g.57484420C>T′,
    pSyntax: ′NP_000507.1:p.R201C′,
    transcSyntax: ′NM_000516.4:c.601C>T′,
    GeneSymbol: ′GNAS′
  }
]
```

This object optionally may be filtered so as to remove the entries at ‘parentRecordNo’ and ‘uniquePropPath’ and to sort the remaining entries by key in a desired order. Optionally, it may be transformed to the familiar comma-separated value (‘csv’) format or other formats.

To improve execution efficiency, the queries in Query E1.2 comprising a pattern to constrain the value of propPath, are re-cast by placing that pattern into a whereFurther clause, as follows:

Query E1.3

```
qGTR_g = {
  find: [“?uniquePropPath”,“?propVal_AS_pSyntax”],
  where: [
    {“?propKey”:“(x) => x === ′pSyntax′”}
  ],
  whereFurther: [
    {“?propPath”:“(x) => x.includes(′cSyntaxes[0]′)”}
  ]
}
```

Programmatic Assembly—In one embodiment, the query sequence Query E1.2, given its structure of chained self-joins, is assembled programmatically by a suitable JavaScript function, wherein the constituent queries preferably are parametric queries that are invoked with the requisite argument provided to the QueryEvaluator, as described in Section 1.2. In a further embodiment, the workflow itself is assembled programmatically by a suitable JavaScript function.

### E.2 Relationship Primitives

This Example illustrates the implementation of RelationshipPrimitives for the GenericTabularRepresentation of the HTML source of the National Cancer Institute web page entitled ‘List of Targeted Therapy Drugs Approved for Specific Types of Cancer’, a section of which is shown in Table E.2.1.

While illustrating the implementation of relationship primitives by the methods of the invention, this Example further illustrates the use of parametrized queries, self-referencing queries and named pattern groups.

TABLE E.2.1

| recordNo | parentRcNo | leaf | level | uniquePropPath |
|---|---|---|---|---|
| 533 | 529 | 0 | 11 | .0-0.1-1.2-148.3-154.4-375.5-378.6-517.7-519.8-522.9-528.10-529.11-533 |
| 534 | 533 | 1 | 11 | .0-0.1-1.2-148.3-154.4-375.5-378.6-517.7-519.8-522.9-528.10-529.11-533 |
| 535 | 533 | 0 | 12 | .0-0.1-1.2-148.3-154.4-375.5-378.6-517.7-519.8-522.9-528.10-529.11-533.12-535 |
| 536 | 535 | 1 | 12 | .0-0.1-1.2-148.3-154.4-375.5-378.6-517.7-519.8-522.9-528.10-529.11-533.12-535 |
| 537 | 535 | 0 | 13 | .0-0.1-1.2-148.3-154.4-375.5-378.6-517.7-519.8-522.9-528.10-529.11-533.12-535.13-537 |
| 538 | 537 | 1 | 14 | .0-0.1-1.2-148.3-154.4-375.5-378.6-517.7-519.8-522.9-528.10-529.11-533.12-535.13-537.14-538 |
| 539 | 533 | 0 | 12 | .0-0.1-1.2-148.3-154.4-375.5-378.6-517.7-519.8-522.9-528.10-529.11-533.12-539 |
| 540 | 539 | 1 | 12 | .0-0.1-1.2-148.3-154.4-375.5-378.6-517.7-519.8-522.9-528.10-529.11-533.12-539 |
| 541 | 539 | 0 | 13 | .0-0.1-1.2-148.3-154.4-375.5-378.6-517.7-519.8-522.9-528.10-529.11-533.12-539.13-541 |
| 542 | 541 | 1 | 13 | .0-0.1-1.2-148.3-154.4-375.5-378.6-517.7-519.8-522.9-528.10-529.11-533.12-539.13-541 |
| 543 | 541 | 1 | 13 | .0-0.1-1.2-148.3-154.4-375.5-378.6-517.7-519.8-522.9-528.10-529.11-533.12-539.13-541 |

| propPath | propKey | propVal | propAttr | SourceId | TimeStamp |
|---|---|---|---|---|---|
| html.body.div.div.div.div.div.main.article.div.div | div | (null) | (null) | (null) | 1692100000000 |
| html.body.div.div.div.div.div.main.article.div.div | div.id | (null) | cgvBody | (null) | 1692100000000 |
| html.body.div.div.div.div.div.main.article.div.div.div | div | (null) | (null) | (null) | 1692100000000 |
| html.body.div.div.div.div.div.main.article.div.div.div | div.class | (null) | blog-intr [symbol] | (null) | 1692100000000 |
| html.body.div.div.div.div.div.main.article.div.div.div.p | p | (null) | (null) | (null) | 1692100000000 |
| html.body.div.div.div.div.div.main.article.div.div.div.p.#text | #text | The FDA has app [symbol] | (null) | (null) | 1692100000000 |
| html.body.div.div.div.div.div.main.article.div.div.div | div | (null) | (null) | (null) | 1692100000000 |
| html.body.div.div.div.div.div.main.article.div.div.div | div.class | (null) | accordio [symbol] | (null) | 1692100000000 |
| html.body.div.div.div.div.div.main.article.div.div.div.nav | nav | (null) | (null) | (null) | 1692100000000 |
| html.body.div.div.div.div.div.main.article.div.div.div.nav | nav.class | (null) | on-this-p [symbol] | (null) | 1692100000000 |
| html.body.div.div.div.div.div.main.article.div.div.div.nav | nav.role | (null) | navigatio [symbol] | (null) | 1692100000000 |

[symbol]

indicates data missing or illegible when filed

### E.2.1 Context Node Selection: Self-Referencing Queries—

First, select a context node of interest, here by specifying values for the attributes propKey and propAttr. In a first embodiment, this is achieved by executing, in sequence, Query E2.1.1, to return a record assigned to cnAttr, and Query E2.1.2, to return the record representing the context node. The latter query illustrates the use of a where-clause referencing an external object, namely cnAttr, by way of the expression $ {cnAttr.parentRecordNo}. The wild-card ‘*’ in the argument of the find clause, mimicking the familiar notation of the SQL SELECT clause, specifies that all attributes are to be included in the retrieved record. As in preceding queries, isEQ denotes a function testing for equality, i.e. isEQ=(x,y)=>x===y.

Query E2.1.1

```
let qGTR_cnAttr = {
  find: [″?*″],
  where: [
    {″?propKey″:”(x) => isEQ(x,′div.class′)”},
    {″?propAttr″:”(x) => isEQ(x,′accordion′)”}
  ]
}
// usage
let cnAttr = queryGTR(qGTR_cnAttr,gtrTb);
```

Query E2.1.2

```
let qGTR_cn = {
  find: [″?*″],
  where: [
    {″?recordNo″:‘(x) =>
isEQ(Number(x),${cnAttr.parentRecordNo})‘}
  ]
}
// usage
let cn = queryGTR(qGTR_cn,gtrTb);
```

The records returned by the two queries are shown in Table E2.1.1 & E2.1.2, respectively. In one embodiment, a function is provided to execute both queries and return the context node.

TABLE E2.1.1
Context Node Attributes

```
{
  rowid: ‘540’,
  recordNo: ‘539’,
  parentRecordNo: ‘533’,
  leaf: ‘0’,
  level: ‘12’,
  uniquePropPath: ‘.0-0.1-1.2-148.3-154.4-375.5-378.6-517.7-519.8-522.9-528.10-529.11-
533.12-539’,
  propPath: ‘html.body.div.div.div.div.div.main.article.div.div.div’,
  propKey: ‘div’,
  propVal: ‘(null)’,
  propAttr: ‘(null)’,
  SourceId: ‘(null)’,
  TimeStamp: ‘1.6921E+12’.
  ‘Annotation\r’: ‘descendant\r’
}
```

TABLE E2.1.2
Context Node

```
{
  rowid: ‘541’,
  recordNo: ‘540’,
  parentRecordNo: ‘539’,
  leaf: ‘1’,
  level: ‘12’,
  uniquePropPath: ‘.0-0.1-1.2-148.3-154.4-375.5-378.6-517.7-519.8-522.9-528.10-529.11-
533.12-539’,
  propPath: ‘html.body.div.div.div.div.div.main.article.div.div.div’,
  propKey: ‘div.class',
  propVal: ‘(null)’,
  propAttr: ‘accordion’,
  SourceId: ‘(null)’,
  TimeStamp: ‘1.6921E+12’,
  ‘Annotation\r’: ‘descendant\r’
}
```

Self-Referencing Query—in a preferred embodiment, the context node in Table E2.1.2 is retrieved more simply and transparently by executing the single self-referencing Query E2.1.3. This query comprises a whereNext clause that references the record set returned by execution of the preceding where (‘w’) clause, namely by way of the substitution variable (‘subVar’) ‘_@w.parentRecordNo@_’, identified by the delimiters ‘_@’ and ‘@_’. The execution model implemented in a preferred embodiment of the Interpreter processes where-clauses in sequence so that the record set returned by executing the where-clause is available prior to instantiating and processing the whereNext-clause.

Query E2.1.3

```
let qGTR_cnByAttr = {
  find: [“?*”],
  where: [
      {“?propKey”:“(x) => isEQ(x,‘div.class')”},
      {“?propAttr”:“(x) => isEQ(x,‘accordion’)”}
  ],
  whereNext: [
    {“?recordNo”:“(x) => isEQ(Number(x),_@w.parentRecordNo@_)”}
  ]
}
// usage
// let cnByAttr = queryGTR(qGTR_cnByAttr,gtrTb,false);
```

### E.2.2 Navigating the Generic Tabular Representation

As a first example, ancestors to the selected context node are identified by executing the parametrized Query E2.2.1, wherein the where clause comprises (strings specifying) variables?uppExpr and?lvExpr that match those in the in clause.

Query E2.2.1

```
let pqGTR = {
  find: [“?recordNo”,“?uniquePropPath”,“?propKey”],
  in: [“?uppExpr”,“?lvExpr”],
  where: [
    {“?uniquePropPath”:“?uppExpr”},
    {“?level”:“?lvExpr”}
  ],
  whereFurther: [
    {“?leaf”:“(x) => Number(x) === 0”}, // exclude leaves
    {“?recordNo”:“(x) => Number(x) > 0”}, // exclude root
    {“?propAttr”:“(x) => x === ‘(null)’”} // exclude ‘extra’ recs
  ]
}
```

Query E2.2.1 also provides a further illustration of the use of a whereFurther-clause; that is, while in one embodiment, the where-clause comprises all patterns, in a preferred embodiment, the where-clause comprises only patterns to be applied to the entire data collection, and the whereFurther clause comprises additional patterns to be applied only to the record set returned by execution of the where-clause. As that record set is smaller than the original data collection, this preferred form of the query reduces the number of operations, and thereby improves execution efficiency.

This query is executed by invoking the function queryGTR with the arguments in the array inClauseArgs_ancestor, as follows:

```
let inClauseArgs_ancestor = [
  `(x) => isPref(x,'${cn.uniquePropPath}')', // specify ancestor
  `(x) => Number(x) < ${cn.level} // exclude self
];
// usage
let qOutp = queryGTR(pqGTR, gtrTb, inClauseArgs_ancestor)
```

As described, query execution proceeds by: first, instantiating the variables in the in-clause by the values specified in the array inClauseArgs_ancestor, wherein context node properties once again are referenced by way of $ { . . . }; next, instantiating the where-clause by referencing the instantiated in-clause.

This produces a record set in the form of an array of 10 objects, with values of recordNo in the set [533, 529, 528, 519, 517, 378, 375, 154, 148, 1], wherein the value of uniquePropPath for each such ancestor satisfies the condition specified in inClauseArg_ancestor, namely that the value of unique PropPath for the selected context node, namely ‘0.0-0.1-1.2-148.3-154.4-375.5-378.6-517.7-519.8-522.9-528.10-529.11-533.12-539’ contain the value of uniquePropPath for any ancestor as a prefix (as may be verified by visual inspection). To obtain the Parent set (comprising a single record), select the most immediate ancestor, by the function expression ‘(x)=>isEQ (Number (x), $ {cn.level}-1).

Other Relationship Primitives—To obtain the Descendant set, execute Query E2.2.1 with appropriately modified arguments, as follows:

```
let inClauseArgs_desc = [
  `(x) => isPref('${cn.uniquePropPath}', x) , // specify descendant
  `(x) => Number(x) > ${cn.level} // exclude self
];
// usage
let qOutp = queryGTR(pqGTR, gtrTb, inClauseArgs_desc)
```

To obtain the Child set, select the first Descendant, by the function expression ‘(x)=>isEQ(Number(x), ${cn.level}+1)’.

In similar fashion, queries for any of the relationship primitives may be implemented, without recursion, by specifying appropriate constraints. For example, Query E2.2.2, wherein the principal constraints in the where-clause pattern now reference parentRecordNo and recordNo, returns the PrecedingSibling or FollowingSibling sets, given appropriate in-clause arguments:

Query E2.2.2

```
let qGTR_precORfollwSib_opt = {
  find: [“?recordNo”,“?leaf”,“?uniquePropPath”,“?propKey”],
  in: [“?pRecNoExpr”,“?recNoExpr”],
  where: [
    {“?parentRecordNo”:“?pRecNoExpr”},
    {“?recordNo”:“?recNoExpr”}
  ],
  whereFurther: [
    {“?propAttr”:“(x) => x === ‘(null)’”} // exclude ‘extra’ records
  ]
}
```

To obtain the PrecedingSibling set, execute Query E2.2.2 by invoking the function queryGTR with the arguments in the array inClauseArgs_pSib, as follows:

```
const inClauseArgs_precSib = [
  ‘(x) => x === ′${cn.parentRecordNo}′‘, // same parent
  ‘(x) => Number(x) > ${cn.recordNo}‘
];
// usage
const qOutp = query(pqGTR, gtrTb, inClauseArgs_precSib)
```

Analogously, to obtain the FollowingSibling set, execute Query E2.2.2 by invoking the QueryEvaluator, queryGTR, with the arguments in the array inClauseArgs_follwSib, as follows:

```
const inClauseArgs_follwSib = [
  `(x) => x === '${cn.parentRecordNo}″, // same parent
  `(x) => Number(x) > ${cn.recordNo}
];
// usage
const qOutp = query(pqGTR, gtrTb, inClauseArgs_follwSib)
```

Defined Relations: SiblingOrSelf—In a preferred embodiment, the self-referencing Query E2.2.3 retrieves the record set defined by SiblingOrSelf as the set of Child relations of the Parent of the selected context node, akin to navigating nodes in a hierarchical document using XPath expressions. To that end, Query 2.2.3 comprises patterns, in a whereNext-clause, wherein the parametrized Predicate Expressions, by way of the substitution variables ‘_@w.uniquePropPath@_’ and ‘_@w.level@_’ reference the Parent record returned by execution of the preceding where-clause. In this embodiment, Query E2.2.3 references the context node by way of the generic interface provided by the in-clause, rather than by explicit reference using template literals.

Execution of this query, with the context node selected above, produces a record set of two siblings, namely the context node itself, identified by recordNo=539, and the additional sibling identified by recordNo=535.

Query E2.2.3

```
let qGTR_sibOrSelf = {
  find: [″?recordNo″,″?level″,″?leaf″,″?uniquePropPath″,″?propKey″],
  in: [″?uppExpr″,″?lvExpr″],
  where: [ // parent
    {″?uniquePropPath″:″?uppExpr″},
    {″?level″:″?lvExpr″},
    {″?propAttr″:″(x) => x === ′(null)′″} // exclude ′extra′ records
  ],
  whereNext: [ // child relations of parent
      {″?uniquePropPath″:″(x) => isPref(′_@w.uniquePropPath@_′,x)″},
      {″?level″:″(x) => Number(x) === _@w.level@_+1″},
      {″?leaf″:″(x) => Number(x) === 0″} // exclude ′extra′ records
  ]
}
// args object defining Parent node by referencing context node object, ‘cn’
const qinArgs_Parent = [
  ‘(x) => isPref(x,′${cn.uniquePropPath}′)‘, // ancestor
  ‘(x) => Number(x) === ${cn.level} − 1‘ // parent
];
// usage
// qOutp = queryGTR(qGTR_sibOrSelf, gtrTb, qinArgs_Parent);
```

### E.3 Transformation Pipeline for Processing a RelationalDataStore

Query E.3.1 illustrates the usage of the pipeline constructor, P, and its chainable methods for devising and executing a transformation pipeline, here applied to the RelationalDataStore, here an array of objects named ‘tb’, of which the first and last entries are shown in the table below:

Query E.3.1

```
new P( )
.SrcQ(new Q( )
  .Find([″?recordNo″,″?level″,″?isLeaf″,″?uniquePropPath″, ?prop Val″])
  .Where([ {″?uniquePropPath″:″(x) => x.includes('0-15')″} ]), tb)
.TxnQ(new Q( ) // operates on data collection returned by preceding query
  .Find([″?recordNo″,″?level″,″?isLeaf″,″?prop Val″])
  .Where([ {″?isLeaf″:″(x) => x == 1″} ])) // leaf nodes only
.TxnQ(new Q( )
  .Find([″ ?* ″])
  .Where([ {″?prop Val″:″(x) => isPref('CD',x)″} ]))
```

| | |
|---|---|
| const gtrTb = [ | . . . |
| { | |
| recordNo: '0', | { |
| parentRecordNo: '-1', | recordNo: '22', |
| isLeaf: '0', | parentRecordNo: '17', |
| level: '0', | isLeaf: '0', |
| uniquePropPath: '.0-0', | level: '2', |
| propPath: ″, | uniquePropPath: '.0-15.1-17.2-22', |
| propKey: ″, | propPath: 'Data.Z', |
| prop Val: ″, | propKey: 'Z', |
| propAttr: ″, | propVal: ″, |
| _tag _: ″, | propAttr: ″ |
| _iteratorIndex __: ″, | _tag _: ″, |
| '_timestamp_\r': '1.69E+12\r' | _iteratorIndex : ″ |
| }, | '_timestamp_\r': '1.69E+12\r' |
| { | }, |
| recordNo: '1', | { |
| parentRecordNo: '0', | recordNo: '23', |
| isLeaf: '1', | parentRecordNo: '22', |
| level: '1', | isLeaf: '1', |
| uniquePropPath: '.0-0.1-1', | level: '3', |
| propPath: 'Label', | uniquePropPath: '.0-15.1-17.2-22.3-23', |
| propKey: 'Label', | propPath: 'Data.Z[0]', |
| prop Val: 'Infectious disease_@X@_ | propKey: '0', |
| is contagious', | prop Val: 'POSITIVE', |
| propAttr: ″, | propAttr: ″, |
| _tag _: ″, | _tag __: ″, |
| _iteratorIndex __: ″, | _iteratorIndex __: ″, |
| '_timestamp_\r': '1.69E+12\r' | '_timestamp __ \r': '1.69E+12\r' |
| }, | }, |
| { | { |
| recordNo: '2', | recordNo: '24', |
| parentRecordNo: '0', | parentRecordNo: '22', |
| isLleaf: '0', | isLeaf: '1', |
| level: '1', | level: '3', |
| uniquePropPath: '.0-0.1-2', | uniquePropPath: '.0-15.1-17.2-22.3-24', |
| propPath: 'Data', | propPath: 'Data.Z[1]', |
| propKey: 'Data', | propKey: '1', |
| prop Val: ″, | prop Val: 'NEGATIVE', |
| propAttr: ″, | propAttr: ″, |
| _tag _: ″, | _tag _: ″, |
| _iteratorIndex _: ″, | _iteratorIndex _: ″, |
| '_timestamp_\r': '1.69E+12\r' | '_timestamp_\r': '1.69E+12\r' |
| }, | }, |
| ... | ]; |

Query E.3.1 first invokes the SrcQ method, which accepts a query object created by the query constructor and executes a sourcing query directed to the relational data store; then successively invokes two instances of the TxnQ method, each of which accepts a query object created by the query constructor and executes a transforming query, the first applied to the result returned by the sourcing query, the second applied to the result of the first transforming query.

This produces an array of two objects that match all constraints expressed in the successive queries:

```
qOutp: [
  { recordNo: '20', level: '3', isLeaf: '1', prop Val: 'CD10' },
  { recordNo: '21', level: '3', isLeaf: '1', prop Val: 'CD23' }
]
```

While the query results in this ‘toy’ example could have been obtained without invoking a transformation pipeline of successive queries, it demonstrates the principle of operation which extends to more general situations/

### E.4 Method Interface for Chained Self-Joins

Box E.4.1 illustrates the use of the merge constructor for implementing a chained self-join. Execution reproduces the array of objects previously obtained, in Example E.1, by chaining self-joins comprising query object literals and invoking the function joinOnExpr; the advantages in terms of transparency afforded by the method interface are evident.

Box E.4.1: Chained self-join

```
export const csj4 = (tb) => {
  return new M( )
  .A(new Q( ) // anchor query
    .Find([″?parentRecordNo″,″?prop Val_AS_id″])
    .Where([{″?propKey″:″(x) => x === 'id''}])
    .Run(tb))
  .Next(new Q( ) // next query
    .Find([″?uniquePropPath″,″?prop Val_AS_gSyntax″])
    .Where([{″?propKey″:″(x) => x === 'gSyntax″'}])
    .Run(tb))
  .On([″(e1,e2) => isSubStr('4-'.concat(e1.parentRecordNo),
e2.uniquePropPath)″]) // a,b
  .By('inner', 'by')
  .Merge( )
  .Next(new Q( )
    .Find([″?uniquePropPath″,″?prop Val_AS_pSyntax″])
    .Where([{″?propKey″:″(x) => x === 'pSyntax″'}])
    .WhereFurther([{″?propPath″:″(x) => x.includes('cSyntaxes[0]')″}])
    .Run(tb))
  .On([″(e1,e2) => isSubStr('4-'.concat(e1.parentRecordNo),
e2.uniquePropPath)″], 'onNext')
  .By('left', 'byNext')
  .MergeNext( )
  .Next(new Q( )
    .Find([″?uniquePropPath″,″?prop Val_AS_transcSyntax″]) //d
    .Where([{″?propKey″:″(x) => x === 'transcSyntax″'}])
    .WhereFurther([{″?propPath″:″(x) => x.includes('cSyntaxes[0]')″}])
    .Run(tb))
  .On([″(e1,e2) => isSubStr('4-'.concat(e1.parentRecordNo),
e2.uniquePropPath)″])
  .By('inner', 'byNext')
  .MergeNext( )
  .Next(new Q( )
    .Find([″?uniquePropPath″, ″?prop Val_AS_GeneSymbol″]) // g
    .Where([{″?propKey″:″(x) => x === 'symbol″'}])
    .WhereFurther([{″?propPath″:″(x) => x.includes('cSyntaxes[0]')″}])
    .Run(tb))
  .On([″(e1,e2) => isSubStr('4-'.concat(e1.parentRecordNo),
e2.uniquePropPath)″], 'onNext')
  .By('inner', 'byNext')
  .MergeNext( )
  .ShowMergeRes( )
}
```

As with the pairwise join of Sect 3.4.1, the methods A & Next each in turn invoke methods defined on the Q constructor to create and execute queries. Merge & MergeNext each perform pairwise joins, in this case self-joins, by invoking the MergeEvaluator: specifically, Merge joins the outputs created by A & Next, on the (in this case single) condition specified in the form of the PredicateExpression provided to the On method, in accordance with the type provided to the By method (with a default set to ‘inner’, wherein other types such as ‘left’ or ‘right’ also may be specified). MergeNext merges the outputs of the preceding Merge and that of subsequent Next steps- and this pattern is then repeated: to specify the conditions for each of these chained merge operations, the second arguments, onNext and byNext, in the respective On and By methods, are set as shown, and these conditions are overwritten in subsequent MergeNext steps. The output of this chained self-join is an array of objects, which may be transformed, in a separate re-formatting step not included here, to produce Table E.1.1.

In one embodiment, the M constructor retains all attributes referenced in Find methods of the two or invoked Q constructors which must include all attributes referenced in the corresponding On method, such as parentRecordNo, in the first pairwise self-join of the preceding query. In alternative embodiment, designated entries of the Find method may be optionally removed by an appropriate filtering step.

The specific methods, procedures, and examples described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention. The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method for querying one or more relational data stores comprising a collection of records, each record in the collection having a user-set number of elements identified by user-named attributes and representing a relation over said attributes, the method comprising:
invoking a query constructor for constructing a query object having properties comprising named query clauses, said named query clauses created by invoking chainable methods defined on the query constructor and comprising at least:
a Find method for creating a find clause for selecting specified attributes and applying aliases, if any, for presenting query output
a Where method for creating a where clause comprising one or more query patterns, each pattern in the form of a key: value pair, the key comprising a string naming an attribute, to be matched against the attributes of the records in one of the relational data stores and the value comprising a constraint, in the form of a predicate expression that may be in the form of a user-defined function, to be applied to the attribute named in the key.
executing the query provided in the form of objects, thereby to select from one of the relational data stores any records matching, or not matching, the constraints in the one or more query patterns, wherein, for any query clause comprising two or more query patterns, the record sets returned by applying each of the query patterns are combined by performing one or more of the following set operations: intersection, corresponding to conjunction, union, corresponding to disjunction, and complement, corresponding to negation;
for join-ing results of a pair of queries, each query directed to a different or to the same relational data store, constructing a merge object by invoking a merge constructor having chainable methods defined thereon for specifying and executing a pairwise join on at least one constraint to be satisfied by pairs of records in said query results,
thereby providing a query language for the relational data stores.

2. The method of claim 1 wherein the methods defined on the query constructor also include at least: In, WhereFurther, WhereNext, WhereNextRc, Update & Method for creating query clauses, the names of methods preferably in upper-case, the names of query clauses in lower-case, but otherwise identical.

3. The method of claim 1 wherein the executing the query is by way of a Run method defined on the query constructor for invoking a QueryEvaluator.

4. The method of claim 2 wherein the in-clause accommodates additional arguments provided to the QueryEvaluator for instantiating parametrized query clauses.

5. The method of claim 1 wherein the method also comprises inferential information retrieval in accordance with relations defined by the analog of rules, which may be recursive.

6. The method of claim 1 wherein query objects may be dynamically created or modified.

7. The method of claim 1 wherein the methods defined on the query constructor also include methods for invoking anonymous or named query factories, wherein a query factory is a function invoking the query constructor for creating a query object and invoking the QueryEvaluator.

8. The method of claim 1 wherein the methods of the merge constructor comprise at least: methods for creating and executing each query in the said pair of queries, by invoking the query constructor; a method for applying the said at least one constraint, provided as a predicate expression; a method for specifying the type of join to be performed; and a method for invoking a MergeEvaluator.

9. The method of claim 1 wherein the executing is by way of a Merge method defined on the merge constructor for invoking a MergeEvaluator.

10. The method of claim 1 wherein, when the constituent queries of a join are directed to the same relational data store, the join is a self-join.

11. The method of claim 1 wherein joins, including self-joins, may be chained.

12. The method of claim 1 wherein the methods of the merge constructor for chaining joins comprise methods for creating and executing at least an additional query, by invoking the query constructor, and methods for merging the results of the said at least one additional query with the result of the immediately preceding join, on at least one new constraint provided as at least one new predicate expression.

13. The method of claim 1 wherein the relational data store is a relational table having a number of columns equal to the record length, wherein attributes appear as column headers, and wherein the constituent elements of the said records are placed into said columns, and records are arranged in rows of the table.

14. The method of claim 1 wherein, when the relational data stores include a relational table conforming to the GenericTabularRepresentation of arbitrarily deeply nested source data, and the methods defined on the query constructor also include named special methods for invoking query factories implementing RelationshipPrimitives and related functions for navigating the GenericTabularRepresentation.

15. The method of claim 1, wherein, when the relational data stores include a relational table conforming to the GenericTabularRepresentation of arbitrarily deeply nested source data, and the methods defined on the merge constructor are invoked to implement Chained Self-Joins for transforming the GenericTabularRepresentation.

16. The method of claim 1 wherein sequences of successive queries are created and executed by invoking methods defined on a pipeline constructor, these methods in turn invoking the query constructor and its constituent methods.

17. A method for querying a collection of records, which may be in tabular format, each record in the collection having a user-set number of elements identified by user-named attributes and representing a relation between said elements, the method comprising:
constructing a query object having query clauses comprising at least a find and a where clause, by invoking a query constructor having at least a first collection of chainable methods comprising at least a Find and a Where method, wherein
invoking the Find or the Where method in said first collection creates a corresponding query clause of the query object, and wherein the where-clause comprises one or more query patterns expressing constraints, in the form of key: value pairs, each constraint to be applied to record elements having an attribute identified in the key, and the value being in the form of a predicate expression; and wherein,
the find-clause specifies the subset of attributes, optionally identified by aliases thereof, to be reported at the completion of the query;
executing the query specified by the said query object by:
applying predicate expressions in the one or more query patterns to identify, for each pattern, a subset of records having elements matching, or not matching, the pattern;
combining the subsets of records so obtained by performing one or more of the following set operations: intersection, corresponding to conjunction, union, corresponding to disjunction, and complement, corresponding to negation;
in accordance with the find-clause, selecting specified attributes and applying the aliases, if any; and
thereby identifying the subset of records satisfying the constraints expressed in the one or more query patterns.

18. The method of claim 17 wherein the said first collection of chainable methods also includes a Run method for invoking a QueryEvaluator and executing comprises invoking the said Run method.

19. The method of claim 18 wherein the said first collection of chainable methods also includes an In method for creating an in clause comprising variables that match variables in the query patterns of the where-clause, and wherein the variables of the in-clause are instantiated by additional arguments provided to the QueryEvaluator.

20. The method of claim 17 wherein the said first collection of chainable methods also includes a WhereFurther method for creating a whereFurther query clause comprising query patterns to be applied to the record subset returned by execution of the where-clause.

21. The method of claim 17 wherein the said first collection of chainable methods also includes a WhereNext method for creating a whereNext clause comprising query patterns referencing the record subset returned by execution of the where-clause.

22. The method of claim 17 wherein the said first collection of chainable methods also includes a WhereNextRc method for creating a recursive whereNext clause comprising query patterns referencing, in a first cycle of recursive query execution, the record subset returned by execution of the where-clause, and in subsequent cycles the record subset returned by execution of the preceding instance of the recursive whereNext-clause.

23. The method of claim 17 wherein the said first collection of chainable methods also includes a Method method for creating a method clause comprising one or more key-value pairs wherein the key references a preceding where-, whereNext-, recursive whereNext- or whereFurther-clause and the value is a predicate expression that may be in the form of a user-defined function, for aggregating or otherwise transforming record subsets returned by execution of the referenced preceding where-, whereNext-, whereNextRc- or whereFurther-clause.

24. The method of claim 17 wherein the query constructor also has a second, extensible collection of chainable methods for invoking and optionally chaining anonymous or named user-defined functions for creating and executing special queries.

25. The method of claim 24 wherein the named user-defined functions create and execute special queries for navigating and transforming a RelationalTable conforming to a GenericTabularRepresentation representing a hierarchically structured or unstructured primary data source.
